(19) United States
(12) Patent Application Publication
(10) Pub. No.: US 2004/0225962 A1
(43) Pub. Date: Nov. 11, 2004

(54) Layout system, layout program, and layout method

(75) Inventors: Hirotaka Ohashi, Suwa-shi (JP); Atsushi Nagahara, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/795,548

(22) Filed: Mar. 9, 2004

(30) Foreign Application Priority Data
Mar. 12, 2003 (JP) 2003-067059
Dec. 26, 2003 (JP) 2003-434180

(51) Int. Cl. G06F 17/21

(52) U.S. Cl. 715/517

(57) ABSTRACT

To provide a layout system that is aesthetically neat even with a margin set in a text information container frame a content delivery terminal segments a text information container frame overlapping another information container frame so that none of the information container frames overlap each other, adjusts the size of a margin and a placement location of one of a plurality of text information container frames so that the spacing between two segmented information container frames having consecutive lines in proximity areas thereof is equal or substantially equal to a line height in each of the text information container frames, and places a selected article into the segmented information container frames.

### BACKGROUND OF THE INVENTION

1. Field of Invention

The present invention relates to a system, a program, a method to lay out post information, such as a document, image, etc., and, in particular, to a layout system, a layout program, and a layout method to provide an aesthetically appealing layout, even if a margin is set in a text information container frame.

2. Description of Related Art

Digital content delivery systems to provide users digital content, such as news, are available in the related art. Such a related art system reads several digital contents from a content registration database (hereinafter database is simply referred to as DB), edits the read digital contents and delivers the edited digital contents to a user. In the course of editing, the digital content is arranged in a layout that is easy for the user to see. For example, related art techniques for layout include a document processing apparatus disclosed in Japanese Unexamined Patent Application Publication No. 6-28344 (hereinafter referred to as first related art).

The first related art includes a frame generating unit that adjusts a next target frame so that the top position thereof is positioned at the final position of a current frame into which digital content is currently fed, and a frame status updating unit to update the size of the area of the current frame by referencing the font size and line height of a content on a sentence by sentence basis. When a sentence straddling across two frames is fed, the line height becomes consistent across the frames.

Even if the font size and line height are changed from paragraph to paragraph, a natural and easy-to-see looking layout results.

### SUMMARY OF THE INVENTION

In accordance with the first related art, the size of the frame is updated referencing the font size and line height. If a margin is set in a text information container frame that receives sentences, resizing the text information container frame only is not sufficient to make line height uniform from text information container frame to text information container frame. Some text information container frames allow an external margin to be arranged along and outside the outline of the text information container frame and an internal margin to be arranged along and inside the outline of the text information container frame. For example, if one of the external margin and the internal margin, each having a width wider than desired line height, is set in the text information container frame, a desired line height cannot be achieved between frames because of the presence of one of the external margin and the internal margin when the text information container frames are set to be close to each other by resizing one of the text information container frames.

It is contemplated that the text information container frames are overlapped disregarding the setting of the margin to achieve the desired spacing between the text information container frames, even with the external margin or the internal margin, each having a width wider than the required line height, set in the text information container frame. However, if the text information container frames are joined, another text information container frame may be adversely affected. For example, when a first text information container frame and another text information container frame are juxtaposed with the top sides thereof aligned at a line, and a second text information container frame is arranged above the first text information container frame and the other text information container frame, if the second text information container frame is expanded in size downward to join the first text information container frame, the second text information container frame automatically joins the other text information container frame.

The present invention has been developed in view of the drawback of the related art. The present invention provides a layout system, a layout program, and a layout method appropriate to achieve an aesthetically appealing layout, even if a text information container frame has a margin set therewithin.

To achieve the above, a layout system of an aspect of the invention includes a layout device to lay out text information. The layout device lays out the text information by placing the text information into a plurality of text information container frames arranged in a predetermined layout area. The text information container frame allows a margin to be set to assure spacing with another text information container frame. The layout device adjusts the size of the margin and the placement location of one of the plurality of text information container frames so that a spacing between two text information container frames having consecutive lines in proximity areas thereof is equal or substantially equal to line height in each of the two text information container frames, when the text information is placed into the plurality of closely arranged text information container frames in a continuous manner.

In this arrangement, the layout device performs a layout process by placing the text information into the plurality of text information container frames arranged in the predetermined layout area. When the text information is placed into the plurality of closely arranged text information container frames in a continuous manner in the layout process, the layout device adjusts the size of the margin and the placement location of one of the plurality of text information container frames so that the spacing between two text information container frames having the consecutive lines in the proximity areas thereof, is equal or substantially equal to the line height in each of the two text information container frames.

The spacing between the text information container frames and the line height in each of the text information container frames are adjusted by modifying the margin size and the placement location of the text information container frame. Accordingly, even if the margin of the text information container frame is set to be larger than a desired line height, the spacing between the text information container frames and the line height in each of the text information container frames are set to be substantially constant. Even with a margin set in each text information container frame, an aesthetically appealing layout is achieved in comparison with the related art.

The margins of the text information container frame include an external margin extending along and outside the outline of the text information container frame, an internal margin extending along and inside the outline of the text information container frame and other margins. The same is true of layout systems, layout programs and layout methods to be discussed below.

The text information container frame is not limited to a rectangular shape only. The text information container frame may be a polygon, a circle, an ellipse, or another geometrical shape. The same is true of the layout programs, the layout systems, and the layout methods to be discussed later.

The term layout refers to a display layout of information to be posted if the information is intended to be displayed on a screen of a display, and refers to a print layout of the information if the information is intended to be printed out on a sheet of paper. The same is true of the layout systems, the layout programs and the layout methods to be discussed later.

The present system may be embodied as a single apparatus, or another apparatus, such as a terminal, or may be embodied as a network system including a plurality of apparatus or a plurality of apparatus, such as terminals. In the latter case, each of elements may belong to any of the plurality of apparatus as long as the elements are linked to each other in communicable manner. The same is true of the layout systems to be discussed later.

The “information container frame” in the context of an aspect of the present invention is a frame within which the text information to be posted is placed in a predetermined layout area. The information container frame includes a virtual (logical) frame. The frame is not necessarily required in the layout unless the frame is drawn as a frame outline. The frame may or may not be visibly recognized. The same is true of the layout systems, the layout programs and the layout methods, to be discussed later.

A layout system of an aspect of the invention includes a layout device to lay out text information. The layout device lays out the text information by placing the text information into a plurality of text information container frames arranged in a predetermined layout area. The text information container frame allows a margin to be set to assure spacing with another text information container frame. The layout device adjusts the size of the margin and the placement location of one of a plurality of text information container frames so that a line height between two text information container frames having a continuous character string of the text information in the proximity areas thereof, and a line height in each of the two text information container frames, fall within a predetermined range, when the text information is split and then placed into the plurality of closely arranged text information container frames.

The second aspect of the invention, although substantially identical to the first aspect of the invention, is stated using different wording to avoid confusion in the understanding of the aspects of the present invention.

As in the first aspect, even if the margin of the text information container frame is set to be larger than a desired line height, the line height between the text information container frames and the line height in each of the text information container frames are set to be substantially constant. Even with a margin set in each text information container frame, a relatively aesthetically appealing layout is achieved in comparison with the related art.

A layout system of a third aspect of the invention includes a post information storage device to store a plurality of pieces of post information containing text information, a post information selecting device to select the post information from among the plurality of pieces of post information in the post information storage device and a layout device to lay out the post information selected by the post information selecting device. The layout device lays out the post information by placing the post information into a plurality of text information container frames arranged in a predetermined layout area. The text information container frame allows a margin to be set to assure spacing with another text information container frame and the layout device adjusts the size of the margin and the placement location of one of the plurality of text information container frames so that a spacing between two text information container frames having consecutive lines in the proximity areas thereof, is equal or substantially equal to a line height in each of the two text information container frames, when the text information is placed into the plurality of closely arranged text information container frames in a continuous manner.

In this arrangement, the post information selecting device selects the post information from among the plurality of pieces of post information in the post information storage device. The layout device lays out the post information by placing the post information into the plurality of text information container frames arranged in the predetermined layout area. When the text information is placed into the plurality of closely arranged text information container frames in a continuous manner, the layout device adjusts the size of the margin and the placement location of one of the plurality of text information container frames so that the spacing between the two text information container frames having the consecutive lines in the proximity areas thereof is equal or substantially equal to the line height in each of the two text information container frames.

The spacing between the text information container frames and the line height in each of the text information container frames are adjusted by modifying the margin size and the placement location of the text information container frame. Even if the margin of the text information container frame is set to be larger than a desired line height, the spacing between the text information container frames and the line height in each of the text information container frames are set to be substantially constant. Even with a margin set in each text information container frame, an aesthetically appealing layout is achieved in comparison with the related art.

The post information storage device stores the information to be posted by any means at any time. The post information storage device may store the information beforehand. Rather than storing the post information beforehand, the post information storage device may store the post information at the input thereof from the outside when the present system operates.

A layout system of a fourth aspect of the invention includes a post information storage device to store a plurality of pieces of post information containing text information, a post information selecting device to select the post information from among the plurality of pieces of post information in the post information storage device and a layout device to lay out the post information selected by the post information selecting device. The layout device lays out the post information by placing the post information into a plurality of text information container frames arranged in a predetermined layout area. The text information container frame allows a margin to be set to assure spacing with another text information container frame. The layout device adjusts the size of the margin and the placement location of one of the plurality of text information container frames so that a line height between two text information container frames having a continuous character string of the text information in the proximity areas thereof and a line height in each of the two text information container frames, fall within a predetermined range, when the text information is split and then placed into the plurality of closely arranged text information container frames.

The fourth aspect, although substantially identical to the third aspect, is stated using different wording to avoid confusion in the understanding of the aspects of the present invention.

As in the third aspect, even if the margin of the text information container frame is set to be larger than a desired line height, the spacing between the text information container frames and the line height in each of the text information container frames are set to be substantially constant. Even with a margin set in each text information container frame, a relatively aesthetically appealing layout is achieved in comparison with the related art.

In a layout system of a fifth aspect of the invention, according to one of the third and fourth aspects, the layout device includes a text information container frame segmenting device to segment one text information container frame overlapping another text information container frame so that none of the text information container frames overlaps each other, a margin adjusting device to adjust the size of the margin and the placement location of a text information container frame segmented by the text information container frame segmenting, and a text information splitting and placement device to place the post information, selected by the post information selecting device, into the text information container frames, segmented by the text information container frame segmenting device, in a continuous manner. The margin adjusting device adjusts the size of the margin and the placement location of one of the plurality of text information container frames segmented by the text information container frame segmenting device so that the spacing between two text information container frames having consecutive lines in the proximity areas thereof, is equal or substantially equal to the line height in each of the two text information container frames.

When one text information container frame overlaps another text information container frame in the above arrangement, the text information container frame segmenting device segments the one text information container frame so that the text information container frames overlaps each other, and the margin adjusting device adjusts the size of the margin and the placement location of one of the plurality of segmented text information container frames so that the spacing between two text information container frames having the consecutive lines in the proximity areas thereof is equal or substantially equal to the line height in each of the two text information container frames. The text information splitting and placement device places the selected post information into the segmented text information container frames in a continuous manner.

When the one text information container frame overlaps the other information container frame depending on the content of the post information, the amount of the post information, and the logical structure of the post information, etc., the one text information container frame is segmented to resolve overlapping state. Subsequent to the segmentation, the spacing between the text information container frames and the line height in each of the text information container frames are set to be substantially constant. Even if the text information container frame overlaps the other information container frame, a relatively aesthetically appealing layout is thus achieved.

The margin adjusting device may perform the adjustment operation prior to the placement of the text information by the text information splitting and placement device or subsequent to the placement of the text information by the text information splitting and placement device.

In a layout system of a sixth aspect of the invention, according to one of the third and fourth aspects, the layout device includes a text information container frame segmenting device to segment one text information container frame overlapping another text information container frame so that none of the text information container frames overlaps each other, margin adjusting device to adjust the size of the margin and the placement location of a text information container frame segmented by the text information container frame segmenting device and a text information splitting and placement device to place the post information, selected by the post information selecting device, into the text information container frames, segmented by the text information container frame segmenting device, in a continuous manner. The margin adjusting device adjusts the size of the internal margin and the placement location of one of the plurality of text information container frames segmented by the text information container frame segmenting device so that the line height between two text information container frames having a continuous character string of the text information in the proximity areas thereof and the line height in each of the two text information container frames, fall within a predetermined range.

The sixth aspect, although substantially identical to the fifth aspect, is stated using different wording to avoid confusion in the understanding of the aspects of the present invention.

As in the fifth aspect, when the one text information container frame overlaps the other text information container frame depending on the content of the post information, the amount of the post information, the logical structure of the post information, etc., the one text information container frame is segmented to resolve an overlapping state. Subsequent to the segmentation, the spacing between the text information container frames and the line height in each of the text information container frames are set to be substantially constant. Even if the one text information container frame overlaps the other text information container frame, a relatively aesthetically appealing layout is thus achieved.

In a layout system of a seventh aspect of the invention, according to one of the fifth and sixth aspects, the margin is an external margin arranged along and outside the outline of the text information container frame.

In this arrangement, the margin adjusting device adjusts the size of the external margin and the placement location of one of the plurality of text information container frames so that subsequent to the segmentation, the spacing between two text information container frames having consecutive lines in the proximity areas thereof, is equal or substantially equal to the line height in each of the two text information container frames. Since the external margin is a margin that extends along and outside the outline of the text information container frame, the spacing of the text information container frame to another text information container frame may be widened or narrowed when the size and the placement location are adjusted.

The spacing between the text information container frames and the line height in each text information container frame are adjusted by modifying the size of the external margin and the placement location of the text information container frame. Even if the external margin of the text information container frame is set to be wider than a desired line height, the spacing between the text information container frames and the line height in each of the text information container frames are set to be substantially constant. Even with a margin set in each text information container frame, an aesthetically appealing layout is achieved in comparison with the related art.

In a layout system of an eighth aspect of the invention, according to one of the fifth through seventh aspects, the margin is an internal margin arranged along and inside the outline of the text information container frame.

In this arrangement, the margin adjusting device adjusts the size of the internal margin and the placement location of one of the plurality of text information container frames so that subsequent to the segmentation, the spacing between two text information container frames having consecutive lines in the proximity areas thereof is equal or substantially equal to the line height in each of the two text information container frames. Since the internal margin is a margin that extends along and inside the outline of the text information container frame, the spacing between the outline of the area except the internal margin of the text information container frame (hereinafter “a content area”) and the outline of the text information container frame may be widened or narrowed when the size is adjusted.

The spacing between the text information container frames and the line height in each text information container frame are adjusted by modifying the size of the internal margin and the placement location of the text information container frame. Even if the internal margin of the text information container frame is set to be wider than a desired line height, the spacing between the text information container frames and the line height in each of the text information container frames are set to be substantially constant. Even with a margin set in each text information container frame, an aesthetically appealing layout is achieved in comparison with the related art.

In a layout system of a ninth aspect of the invention, according to the eighth aspect, the text information container frame is a rectangular information container frame that receives text information in a horizontal writing format therewithin. When a first text information container frame of the plurality of text information container frames is wider in width than a second text information container frame of the plurality of text information container frames, the margin adjusting device reduces the size of the internal margin on the top side of the second text information container frame to zero or almost zero and adjusts the placement location of the second text information container frame so that the top side of the second text information container frame is positioned at the upper edge of the internal margin of the bottom side of the first text information container frame. The text information splitting and placement device places the post information, selected by the post information selecting device, into the first text information container frame and places a continuation of the post information, placed in the first text information container frame, into the second text information container frame.

If the first text information container frame is wider in width than the second text information container frame in this arrangement, the margin adjusting device reduces the size of the internal margin of the top side of the second text information container frame to zero or almost zero and adjusts the placement location of the second text information container frame so that the top side of the second text information container frame is positioned at the upper edge of the internal margin of the bottom side of the first text information container frame. The text information splitting and placement device places the selected post information into the first text information container frame and places the continuation of the post information, placed in the first text information container frame, into the second text information container frame.

When the post information is placed in the horizontal writing format, the second text information container frame and another information container frame are juxtaposed with the top edges thereof horizontally aligned as a result of text information container frame segmentation by the text information container frame segmenting device. The first text information container frame may be arranged above the second text information container frame and the other text information container frame. If the first text information container frame is moved downward to join the second text information container frame to adjust the spacing between the text information container frames in such a case, the first text information container frame also joins the other text information container frame.

In accordance with the present aspect of the present invention, the second text information container frame is moved upward to join the first text information container frame in the same case. This arrangement reduces the possibility that one of the first text information container frame and the second text information container frame joins the other text information container frame. An even more aesthetically appealing layout is thus achieved.

The width of the text information container frame refers to the width horizontally across the text information container frame and is measured along a direction identical or substantially identical to the direction of lines when the post information is placed in the horizontal writing format. The same is true of the following layout systems.

In a layout system of a tenth aspect of the invention, according to the eighth aspect, the text information container frame is a rectangular information container frame that receives text information in a horizontal writing character string format therewithin. When the length of an adjacent first text information container frame of a plurality of text information container frames is longer in the direction of a character string than the length of a second text information container frame of the plurality of text information container frames adjacent to the first text information container frame, the margin adjusting device reduces the internal margin of a side of the second text information container frame to be in contact with the first text information container frame to zero or almost zero, and adjusts the placement location of the second text information container frame so that the side of the second text information container frame to be in contact with the first text information container frame, is positioned at the character string edge of the internal margin of a side of the first text information container frame to be in contact with the second text information container frame. The text information splitting and placement device places the post information, selected by the post information selecting device, into the first text information container frame, and places a continuation of the post information, placed in the first text information container frame, into the second text information container frame.

The tenth aspect, although substantially identical to the ninth aspect, is stated using different wording to avoid confusion in the understanding of the aspects of the present invention. Like the ninth aspect, the tenth aspect provides an even more aesthetically appealing layout.

The character string edge of the internal margin refers to the edge of the internal margin, closer to the character string accommodated in the text information container frame, and farther apart from the outline of the text information container frame, among the edges of the internal margin. The same is true of the layout systems to be discussed below.

In a layout system of an eleventh aspect of the invention, according to the eighth aspect, the text information container frame is a rectangular information container frame that receives text information in a horizontal writing format therewithin. When a first text information container frame of the plurality of text information container frames is narrower in width than a second text information container frame of the plurality of text information container frames, the margin adjusting device reduces the size of the internal margin on the bottom side of the first text information container frame to zero or almost zero and adjusts the placement location of the first text information container frame so that the bottom side of the first text information container frame is positioned at the lower edge of the internal margin of the top side of the second text information container frame. The text information splitting and placement device places the post information, selected by the post information selecting device, into the first text information container frame and places a continuation of the post information, placed in the first text information container frame, into the second text information container frame.

If the first text information container frame is narrower in width than the second text information container frame in this arrangement, the margin adjusting device reduces the size of the internal margin of the bottom side of the first text information container frame to zero or almost zero and adjusts the placement location of the first text information container frame so that the bottom side of the first text information container frame is positioned at the lower edge of the internal margin of the top side of the second text information container frame. The text information splitting and placement device places the selected post information into the first text information container frame and places a continuation of the post information, placed in the first text information container frame, into the second text information container frame.

When the post information is placed in the horizontal writing format, the first text information container frame and another information container frame are juxtaposed with the bottom edges thereof horizontally aligned as a result of text information container frame segmentation by the text information container frame segmenting device. The second text information container frame may be arranged below the first text information container frame and the other text information container frame. If the second text information container frame is moved upward to join the first text information container frame to adjust the spacing between the text information container frames in such a case, the second text information container frame also joins the other text information container frame.

In accordance with an aspect of the present invention, the first text information container frame is moved downward to join the second text information container frame in the same case. This arrangement reduces the possibility that one of the first text information container frame and the second text information container frame joins the other text information container frame. An even more aesthetically appealing layout is thus achieved.

In a layout system of a twelfth aspect of the invention, according to the eighth aspect, the text information container frame is a rectangular information container frame that receives text information in a horizontal writing character string format therewithin, and when the length of a first text information container frame of a plurality of text information container frames is shorter in the direction of character string than the length of a second text information container frame of the plurality of text information container frames adjacent to the first text information container frame, the margin adjusting device reduces the internal margin of a side of the first text information container frame to be in contact with the second text information container frame to zero or almost zero and adjusts the placement location of the first text information container frame so that the side of the first text information container frame to be in contact with the second text information container frame is positioned at the character string edge of the internal margin of a side of the second text information container frame to be in contact with the first text information container frame. The text information splitting and placement device places the post information, selected by the post information selecting device, into the first text information container frame, and places a continuation of the post information, placed in the first text information container frame, into the second text information container frame.

The twelfth aspect, although substantially identical to the eleventh aspect, is stated using different wording to avoid confusion in the understanding of the aspect of the present invention. Like the eleventh aspect, the twelfth aspect provides an even more aesthetically appealing layout.

In a layout system of a thirteenth aspect of the invention, according to the eighth aspect, the text information container frame is a rectangular information container frame that receives text information in a vertical writing format therewithin. When a first text information container frame of the plurality of text information container frames is longer in vertical length than a second text information container frame of the plurality of text information container frames, the margin adjusting device reduces the size of the internal margin on the right side of the second text information container frame to zero or almost zero and adjusts the placement location of the second text information container frame so that the right side of the second text information container frame is positioned at the right edge of the internal margin of the left side of the first text information container frame. The text information splitting and placement device places the post information, selected by the post information selecting device, into the first text information container frame, and places a continuation of the post information, placed in the first text information container frame, into the second text information container frame.

If the first text information container frame is longer in vertical length than the second text information container frame in this arrangement, the margin adjusting device reduces the size of the internal margin of the right side of the second text information container frame to zero or almost zero and adjusts the placement location of the second text information container frame so that the right side of the second text information container frame is positioned at the right edge of the internal margin of the left side of the first text information container frame. The text information splitting and placement device places the selected post information into the first text information container frame and places a continuation of the post information, placed in the first text information container frame, into the second text information container frame.

When the post information is placed in the vertical writing format, the second text information container frame and another information container frame are arranged one frame above the other with the right edges thereof vertically aligned as a result of text information container frame segmentation by the text information container frame segmenting device. The first text information container frame may be arranged on the right hand side of the second text information container frame and the other text information container frame. If the first text information container frame is moved leftward to join the second text information container frame to adjust the spacing between the text information container frames in such a case, the first text information container frame also joins the other text information container frame.

In accordance with an aspect of the present invention, the second text information container frame is moved rightward to join the first text information container frame in the same case. This arrangement reduces the possibility that one of the first text information container frame and the second text information container frame joins the other text information container frame. An even more aesthetically appealing layout is thus achieved.

The vertical length of the text information container frame refers to the height of the text information container frame and is measured along a direction identical or substantially identical to the direction of a column when the post information is placed in the vertical writing format.

In a layout system of a fourteenth aspect of the invention, according to the eighth aspect, the text information container frame is a rectangular information container frame that receives text information in a vertical writing character string format therewithin. When the length of an adjacent first text information container frame of a plurality of text information container frames is longer in the direction of character string than the length of a second text information container frame of the plurality of text information container frames adjacent to the first text information container frame, the margin adjusting device reduces the internal margin of a side of the second text information container frame to be in contact with the first text information container frame to zero or almost zero, and adjusts the placement location of the second text information container frame so that the side of the second text information container frame to be in contact with the first text information container frame is positioned at the character string edge of the internal margin of a side of the first text information container frame to be in contact with the second text information container frame. The text information splitting and placement device places the post information, selected by the post information selecting device, into the first text information container frame and places a continuation of the post information, placed in the first text information container frame, into the second text information container frame.

The fourteenth aspect, although substantially identical to the thirteenth aspect, is stated using different wording to avoid confusion in the understanding of the aspect of the present invention. Like the thirteenth apsect, the fourteenth aspect provides an a even more esthetically appealing layout.

In a layout system of a fifteenth aspect of the invention, according to the eighth aspect, the text information container frame is a rectangular information container frame that receives text information in a vertical writing format therewithin. When a first text information container frame of the plurality of text information container frames is shorter in vertical length than a second text information container frame of the plurality of text information container frames, the margin adjusting device reduces the size of the internal margin on the left side of the first text information container frame to zero or almost zero and adjusts the placement location of the first text information container frame so that the left side of the first text information container frame is positioned at the left edge of the internal margin of the right side of the second text information container frame. The text information splitting and placement device places the post information, selected by the post information selecting device, into the first text information container frame and places a continuation of the post information, placed in the first text information container frame, into the second text information container frame.

If the first text information container frame is shorter in vertical length than the second text information container frame in this arrangement, the margin adjusting device reduces the size of the internal margin of the left side of the first text information container frame to zero or almost zero and adjusts the placement location of the first text information container frame so that the left side of the first text information container frame is positioned at the left edge of the internal margin of the right side of the second text information container frame. The text information splitting and placement device places the selected post information into the first text information container frame and places the continuation of the post information, placed in the first text information container frame, into the second text information container frame.

When the post information is placed in the vertical writing format, the first text information container frame and another information container frame are arranged one frame above the other with the left edges thereof vertically aligned as a result of text information container frame segmentation by the text information container frame segmenting device. The second text information container frame may be arranged on the left hand side of the first text information container frame and the other text information container frame. If the second text information container frame is moved rightward to join the first text information container frame to adjust the spacing between the text information container frames in such a case, the second text information container frame also joins the other text information container frame.

In accordance with an aspect of the present invention, the first text information container frame is moved leftward to overlap the second text information container frame in the same case. This arrangement reduces the possibility that one of the first text information container frame and the second text information container frame overlaps the other text information container frame. An even more aesthetically appealing layout is thus achieved.

In a layout system of a sixteenth aspect of the invention, according to the eighth aspect, the text information container frame is a rectangular information container frame that receives text information in a vertical writing character string format therewithin. When the length of an adjacent first text information container frame of a plurality of text information container frames is shorter in the direction of character string than the length of a second text information container frame of the plurality of text information container frames adjacent to the first text information container frame, the margin adjusting device reduces the internal margin of the side of the first text information container frame to be in contact with the second text information container frame to zero or almost zero and adjusts the placement location of the first text information container frame so that the side of the first text information container frame to be in contact with the second text information container frame is positioned at the character string edge of the internal margin of a side of the second text information container frame to be in contact with the first text information container frame. The text information splitting and placement device places the post information, selected by the post information selecting device, into the first text information container frame and places a continuation of the post information, placed in the first text information container frame, into the second text information container frame.

The sixteenth aspect, although substantially identical to the fifteenth aspect, is stated using different wording to avoid confusion in the understanding of the aspects of the present invention. Like the fifteenth aspect, the sixteenth aspect provides an even more aesthetically appealing layout.

A layout system of a seventeenth aspect of the invention, according to one of the fifth through sixteenth aspects, further includes an outline determining device to determine an outline of a merged area that is obtained by merging the plurality of text information container frames segmented by the text information container frame segmenting device, and outline drawing device to draw the outline of the merged area based on the results of determination of the outline determining device.

In this arrangement, the outline determining device determines the outline of the merged area that is obtained by merging the plurality of text information container frames segmented by the text information container frame segmenting device and the outline drawing device draws the outline of the merged area based on the results of determination of the outline determining device.

Since the outline of the merged area is drawn, the plurality of segmented text information container frames is easily and visibly recognized as a logically unitary entity.

The determination of the merged area by the outline determining device may be performed prior to or subsequent to the adjustment operation of the margin adjusting device and the placement operation of the text information splitting and placement device. The same is true of the drawing operation of the outline drawing means.

In a layout system of an eighteenth aspect of the invention, according to the seventeenth aspect, the outline determining device excludes an entire length of a side of the text information container frame as a candidate side forming the outline of the merged area if the side of the text information container frame entirely coextends with another text information container frame, excludes a portion of the side as a candidate side forming the outline of the merged area if the portion of the side of the text information container frame coextends with another text information container frame and adopts a side of the text information container frame as a candidate side forming the outline of the merged area if the side of the text information container frame does not coextend at all with another text information container frame. The outline determining device determines the sides of the outline of the merged area based on the candidate sides determined on all sides of the text information container frames forming the merged area.

In this arrangement, the outline determining device excludes the entire length of the side of the text information container frame as the candidate side forming the outline of the merged area if the side of the text information container frame entirely coextends with another text information container frame. The outline determining device excludes the portion of the side as a candidate side forming the outline of the merged area if the portion of the side of the text information container frame coextends with another text information container frame. The outline determining device adopts the side of the text information container frame as the candidate side forming the outline of the merged area if the side of the text information container frame does not coextend at all with another text information container frame. The outline determining device determines the sides of the outline of the merged area based on the candidate sides determined on all sides of the text information container frames forming the merged area.

In this way, the outline of the merged area is relatively correctly determined.

A layout system of a nineteenth aspect of the invention, according to one of the third through the eighteenth aspects, further includes a user information storage device to store user information relating to a user, the post information selecting device selects the post information from among the plurality of pieces of post information based on the user information in the user information storage device.

In this arrangement, the post information selecting device selects the post information from among the plurality of pieces of post information based on the user information in the user information storage device.

Since information unique to a user and information designated by the user are referenced concerning the selection of the post information, the layout system produces the layout having a content generally faithfully reflecting the desire of the user.

The user information here contains the age, the sex, the personal preferences, the address, and the name of the user, and an operational environment relating to a user terminal, for example. The same is true of the following layout systems.

The user information storage device stores the user information by any device at any time. The user information storage means may store the information beforehand. Rather than storing the user information beforehand, the user information storage device may store the user information at the input thereof from the outside when the present system operates. The same is true of the layout systems to be discussed below.

A layout system of a twentieth aspect of the invention, according to one of the third through eighteenth aspects, includes a user information storage device that stores user information relating to a user, the post information selecting device selecting the post information from among the plurality of pieces of post information based on the user information in the user information storage device.

The twentieth aspect, although substantially identical to the nineteenth aspect, is stated using different wording to avoid confusion in the understanding of the aspect of the present invention.

As in the nineteenth aspect, the layout system produces the layout having a content generally faithfully reflecting the desire of the user.

A layout system of a twenty first aspect of the invention, according to one of the third through eighteenth aspects, further includes a user information storage device to store user information relating to a user, the layout device lays out the post information, selected by the post information selecting device, based on the user information in the user information storage device.

The layout device lays out selected post information, based on the user information in the user information storage device.

Since the information unique to a user and the information designated by the user are referenced concerning the layout, the layout system produces the layout having a content generally faithfully reflecting the desire of the user.

The layout process may be performed based on the user information. When the user information contains the age information of the user, the use of a relatively large font size is contemplated if the user is a relatively aged person. When the user information contains the sex information, the layout of using a rounded font is contemplated if the user is female, for example. When the user information contains interest and preference information, the use of, for example, a layout more like magazines intended for children, more like sport journals, or more like technical documents is contemplated depending on the interest and preference of the user. If the user information contains address information, a layout having the scene of an area corresponding to the address as a background is contemplated. If the user information contains the name of the user, a layout having the name thereof as a title is contemplated. If the user information contains information of the operational environment relating to the user terminal, a layout that avoids the use of an image of a large amount of data may be adopted when the capacity of an RAM of the user terminal is small.

A layout system of a twenty second aspect of the invention, according to one of the third through eighteenth aspects, includes a user information storage device that stores user information relating to a user, the layout device lays out the post information, selected by the post information selecting device, based on the user information in the user information storage device.

The twenty second aspect, although substantially identical to the twenty first aspect, is stated using different wording to avoid confusion in the understanding of the aspect of the present invention.

As in the twenty first aspect, the layout system produces the layout having a content generally faithfully reflecting the desire of the user.

A program of a twenty third aspect of the invention causes a computer to perform a process of the layout device in a layout system according to one of the first and second aspects, wherein the text information container frame allowing a margin to be set to assure spacing with another text information container frame, and the layout device adjusts the size of the margin and the placement location of one of the plurality of text information container frames so that the spacing between two text information container frames having consecutive lines in the proximity areas thereof is equal or substantially equal to the line height in each of the two text information container frames, when the text information is placed into the plurality of closely arranged text information container frames in a continuous manner.

In this arrangement, the computer reads the program, and performs the process in accordance with the read program. The layout program of the twenty third aspect thus provides the same effect and advantages as those of the layout system of the first aspect.

A program of a twenty fourth aspect of the invention causes a computer to perform a process of the layout device in a layout system according to one of the first and second aspects, the text information container frame allowing a margin to be set to assure spacing with another text information container frame and the layout device adjusts the size of the margin and the placement location of one of the plurality of text information container frames so that the line height between two text information container frames having consecutive lines in the proximity areas thereof and the line height in each of the two text information container frames fall within a predetermined range, when the text information is placed into the plurality of closely arranged text information container frames in a continuous manner.

The twenty fourth aspect, although substantially identical to the twenty third aspect, is stated using different wording to avoid confusion in the understanding of the aspect of the present invention.

As in the twenty third aspect, the layout system produces the layout having a content generally faithfully reflecting the desire of the user.

A layout method of a twenty fifth aspect of the invention includes a layout step to lay out text information, the layout step including placing the text information into a plurality of text information container frames arranged in a predetermined layout area, the text information container frame allowing a margin to be set to assure spacing with another text information container frame, and the size of the margin and the placement location of one of the plurality of text information container frames adjusted in the layout step so that the spacing between two text information container frames having consecutive lines in the proximity areas thereof is equal or substantially equal to the line height in each of the two text information container frames, when the text information is placed into the plurality of closely arranged text information container frames in a continuous manner.

The layout method of the twenty fifth aspect provides the same advantage as those of the layout system of the first aspect.

A layout method of a twenty sixth aspect of the invention includes a layout step to lay out text information, the layout step including placing the text information into a plurality of text information container frames arranged in a predetermined layout area, the text information container frame allowing a margin to be set to assure spacing with another text information container frame, and the size of the margin and the placement location of one of the plurality of text information container frames adjusted in the layout step so that the line height between two text information container frames having consecutive lines in the proximity areas thereof and the line height in each of the two text information container frames fall within a predetermined range, when the text information is placed into the plurality of closely arranged text information container frames in a continuous manner.

The twenty sixth aspect, although substantially identical to the twenty fifth aspect, is stated using different wording to avoid confusion in the understanding of the aspects of the present invention. The layout method of the twenty sixth aspect provides the same advantage as the layout method of the twenty fifth aspect.

### BRIEF DESCRIPTION OF THE DRAWINGS

FIG. 1 is a block schematic illustrating the structure of a network system implementing an aspect of the present invention;

FIG. 2 is a functional block schematic illustrating major functions of a content delivery terminal 100;

FIG. 3 is a block schematic illustrating the structure of the content delivery terminal 100;

FIG. 4 is a schematic illustrating the data structure of a user profile table 300;

FIG. 5 illustrates a layout state defined by a page template;

FIG. 6 illustrates the data structure of an information container frame and the margin thereof;

FIG. 7 illustrates the data structure of a template application rule;

FIG. 8 illustrates the data structure of the template application rule;

FIG. 9 illustrates the data structure of a layout number correspondence table 330;

FIG. 10 illustrates the data structure of a digital content and a category number correspondence table 340;

FIG. 11 is a flowchart illustrating a user registration process;

FIG. 12 is a flowchart of a content delivery process;

FIG. 13 is a flowchart of an automatic layout process;

FIG. 14 is a flowchart illustrating a first placement process to place content into the information container frame;

FIG. 15 illustrates a layout state in which information container frames overlap each other;

FIG. 16 illustrates a layout state from which the text information container frame P is segmented;

FIG. 17 illustrates how line height lh is calculated;

FIG. 18 illustrates how the sizes of margins and placement locations of the text information container frames P0 and P1 are adjusted;

FIG. 19 illustrates how the sizes of margins and placement locations of the text information container frames P1 and P2 are adjusted;

FIG. 20 is a flowchart illustrating a first placement process for an information container frame;

FIG. 21 illustrates a layout state in which information container frames overlap each other;

FIG. 22 illustrates a layout state from which the text information container frame P is segmented;

FIG. 23 illustrates how line height lh is calculated;

FIG. 24 illustrates drawn outlines of the text information container frames P0-P2;

FIG. 25 illustrates a drawn outline of a merged area containing the text information container frames P0-P2; and

FIG. 26 illustrates the information container frame and the structure thereof.

### DETAILED DESCRIPTION OF EXEMPLARY EMBODIMENTS

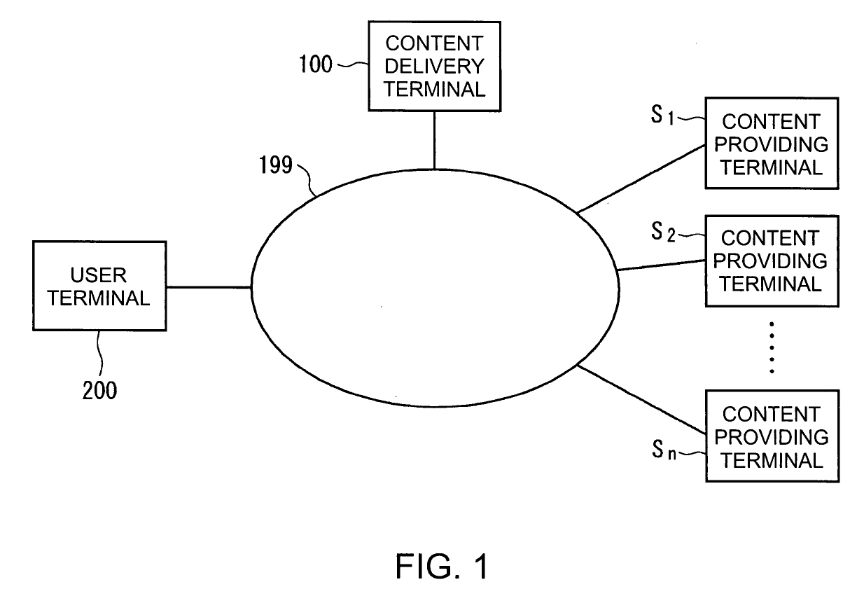

The embodiments of the present invention will now be discussed with reference to the drawings. FIGS. 1 through 19 illustrate a layout system, a layout program, and a layout method in accordance with a first exemplary embodiment of the present invention.

The layout system, the layout program, and the layout method in accordance with the exemplary embodiments of the present invention are applied to a system in which a content delivery terminal 100 delivers digital contents, such as news, to a user terminal 200 as shown in FIG. 1. In accordance with the present exemplary embodiment, a horizontal writing format is set in a text information container frame, and horizontally written text information is placed into the text information container frame.

The structure of an exemplary network system implementing the aspects of the present invention is discussed with reference to FIG. 1.

FIG. 1 is a block schematic illustrating the structure of the exemplary network system implementing the present invention.

Connected to the Internet 199 are a plurality of content providing terminals S1-Sn to provide digital content, a content delivery terminal 100 that collects, stores, and delivers the digital contents provided by the content providing terminals S1-Sn (hereinafter the digital contents supplied by the content providing terminals S1-Sn are also referred to as article information or simply articles), and a user terminal 200 used by a user. For easy understanding of the present invention, a single user terminal 200 is shown. In practice, a plurality of user terminals may be connected to the Internet 199.

Each of the content providing terminals S1-Sn have the same function as a typical computer having a CPU, an ROM, an RAM, interfaces, etc., connected to each other through a bus. When digital content is produced, a category number identifying the category of the digital content is attached to the digital content. The digital content with the category number attached thereto is sent to the content delivery terminal 100. The category number will be discussed more in detail later.

The user terminal 200 has the same function as a typical computer having a CPU, an ROM, an RAM, interfaces, etc., connected to each other through a bus. The user terminal 200 has a WWW (World Wide Web) browser. Using the WWW browser, the user terminal 200 accesses the content delivery terminal 100.

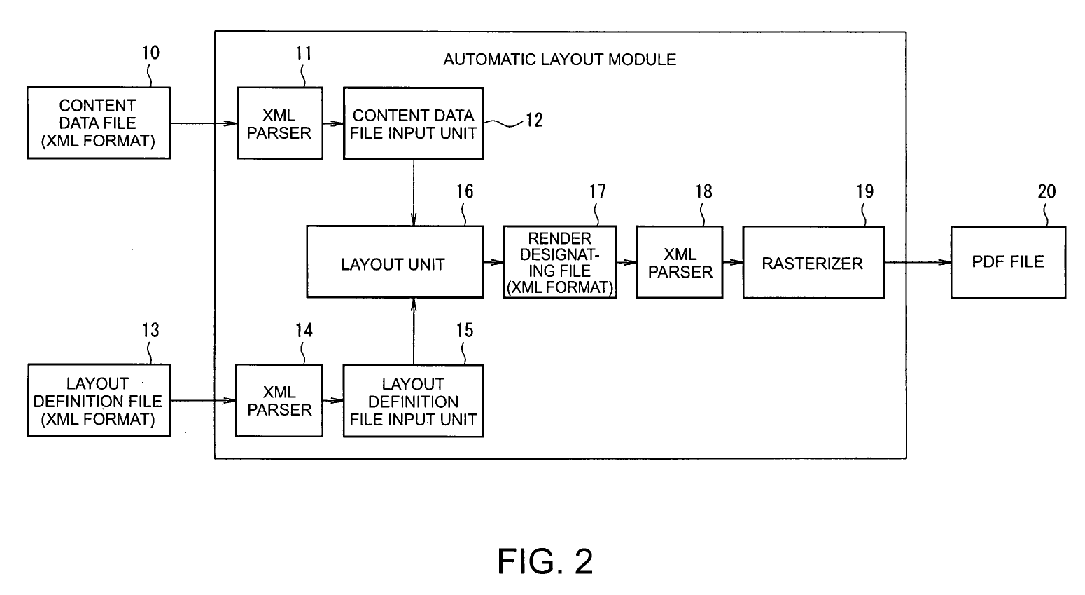

The major functions of the content delivery terminal 100 will be described in detail with reference to FIG. 2.

FIG. 2 is a functional block schematic illustrating the major functions of the content delivery terminal 100.

Referring to FIG. 2, the content delivery terminal 100 includes an XML parser 11 to parse a content data file 10 in an XML (eXtensive Markup Language), a content data file input unit 12 to input the content data file 10 parsed by the XML parser 11, an XML parser 14 to analyze an layout definition file 13 (referring to a page template and a template application rule to be discussed later) in an XML, a layout definition file input unit 15 to input the layout definition file 13 parsed by the XML parser 14, a layout unit 16 to perform a layout process based on the content data file 10 and the layout definition file 13 respectively received through the input units 12 and 15, an XML parser 18 to parse an XML render designating file 17 from the layout unit 16, and a rasterizer 19 to produce a file 20 in a PDF (Portable Document Format) by performing rendering based on the XML render designating file 17 parsed by the XML parser 18. Particularly, the feature of this exemplary embodiment of the present invention lies in the layout unit 16 among other elements.

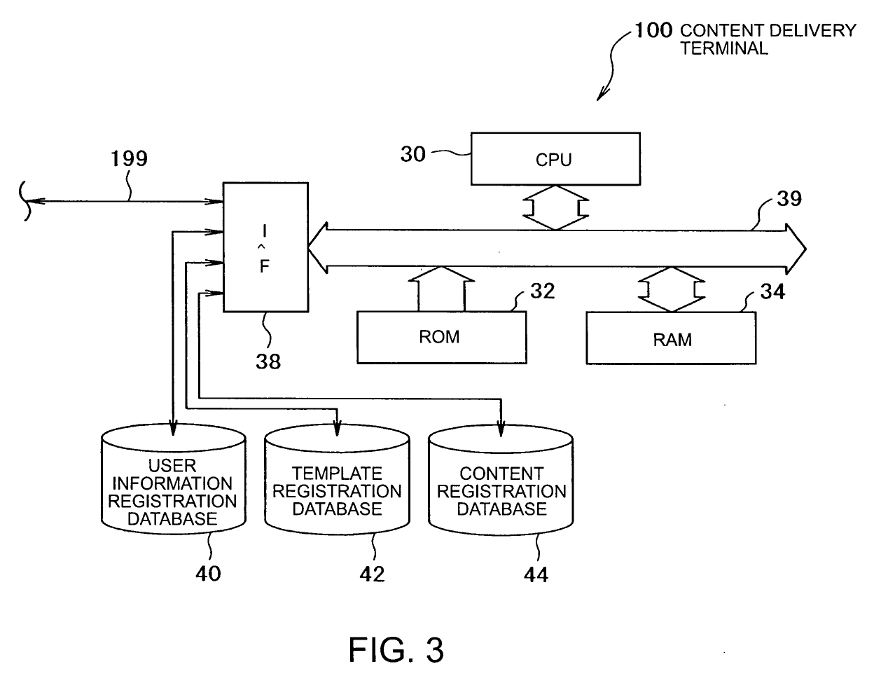

Referring to FIG. 3, the content delivery terminal 100 will now be discussed in detail.

FIG. 3 is a block schematic of the content delivery terminal 100.

As shown, the content delivery terminal 100 includes a CPU 30 to perform arithmetic operation and control the entire system based on a control program, an ROM 32 to store beforehand the control program, etc., of the CPU 30 in a predetermined area thereof, an RAM 34 to store data read from the ROM 32 or the like and calculation results required in the course of the arithmetic operation of the CPU 30, and an interface 38 to interface with an external device to exchange data. To exchange data, these elements are mutually interconnected by a bus 39, as a signal line to transfer data.

Connected to the interface 38 are, as external units, a user information registration DB 40 to register user information, a template registration DB 42 to register a page template defining the frame structure of a layout in a layout area on a per page basis, a content registration DB 44 to collect and store digital contents supplied by the content providing terminals S1-Sn and a signal line connected to the Internet 199.

The data structure of the user information registration DB 40 is discussed below with reference to the drawings.

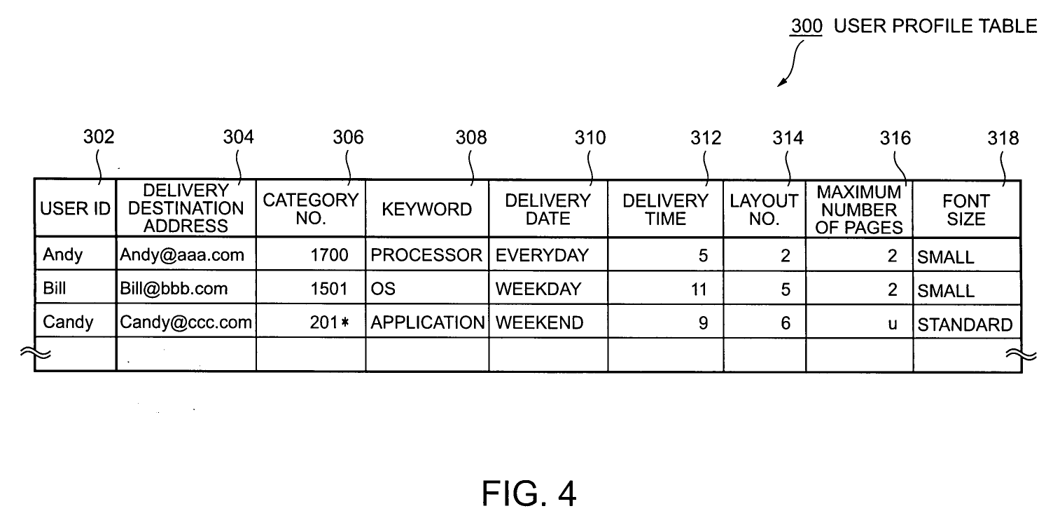

As shown in FIG. 4, the user information registration DB 40 stores a user profile table 300 having user information registered therewithin.

FIG. 4 illustrates the data structure of the user profile table 300.

The user profile table 300 registers a single or a plurality of records for each user, as shown in FIG. 4. Each record includes a field 302 to register a user ID to identify a user, a field 304 to register a destination address of a digital content, a field 306 to register a category number, a field 308 for registering a keyword, a field 310 to register the date of delivery, a field 312 to register the time of delivery, a field 314 to register a layout number, a field 316 to register the maximum number of pages, and a field 318 to register a font size.

When a digital content containing a keyword designated by a user is selected as data to be delivered, the field 308 registers that keyword. The keyword may be the one that appears most frequently in the document of a category in which the user is interested. Referring to FIG. 4, a “PROCESSOR” is registered in a first row of the field 308, and an “OS (Operating System)” is registered in a second row of the field 308.

The field 310 registers the date of delivery on which the user desires the delivery of the digital content. For example, when the delivery of the digital content is desired everyday, “EVERYDAY” is designated. When the delivery of the digital content is desired on a weekday only, a “WEEKDAY” is designated. When the delivery of the digital content is desired on a weekend, a “WEEKEND” is designated. Referring to FIG. 4, “EVERYDAY” is registered in a first row of the field 310, and a “WEEKDAY” is registered in a second row of the field 310.

The field 312 registers the time of delivery of the digital content on the delivery date designated by the user. As the time of delivery, one day may be divided into 24 hours from a zero hour slot to a twenty-third hour slot, and any time slot is designated. Referring to FIG. 4, a fifth hour slot is registered in a first row of the field 312, and an eleventh hour slot is registered in a second row in the field 312.

The field 314 registers the layout number to identifying the output layout of the digital content. For example, the layout number identifies the output layout desired by the user. Referring to FIG. 4, layout number 2 is registered in a first row of the field 314 and layout number 5 is registered in a second row of the field 314. The layout number will be discussed in detail later.

The field 316 registers the maximum number of pages at the upper limit when the digital content is displayed or printed out. The maximum number of pages designates the maximum number of pages at the upper limit. Alternatively, the letter “u” may be designated to set no upper limit. Referring to FIG. 4, “2” pages are registered in a first row of the field 316, and the letter “u” is registered in a third row of the field 316.

The field 318 registers the font size when the digital content is displayed or printed out. Referring to FIG. 4, a “SMALL” font is registered in a first row of the field 318, and a “STANDARD” font is registered in a third row of the field 318.

Referring to the drawings, the data structure of the template registration DB 42 is discussed.

The template registration DB 42 stores a plurality of different page templates.

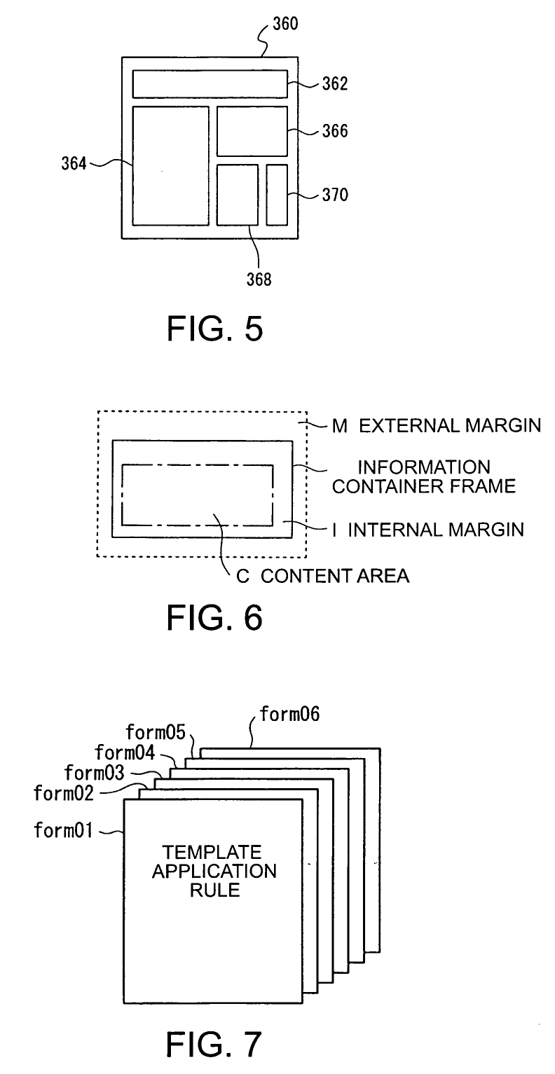

The structure of the page template is discussed with reference to FIG. 5.

FIG. 5 illustrates a layout state defined by a page template. As shown in FIG. 5, the page template defines the layout state in which a title information container frame in a rectangular form 362 to contain title information therewithin, a text information container frame in a rectangular form 364 for containing text information therewithin, image information container frame 366 and image information containing frame 368 each in a rectangular form, to contain image information, and a text information container frame 370 are arranged in a layout area 360. A horizontal writing format is set in a text information container frame, and horizontally writing text information is placed into the text information container frame. FIG. 5 illustrates one example only, and the shapes, the sizes, and the number of the information container frames, and the locations of the information container frames within the layout area 360 are different from page template to page template.

FIG. 6 illustrates the structure of the information container frame and the margins thereof.

As shown, the information container frame allows, to be set, an external margin M that extends along and outside the outline of the information container frame and an internal margin I that extends along and inside the outline of the information container frame. The external margin M defines the spacing between the outline of the information container frame and the outline of another information container frame, and the internal margin I defines the spacing between the outline of a rectangular content area C and the outline of the information container frame.

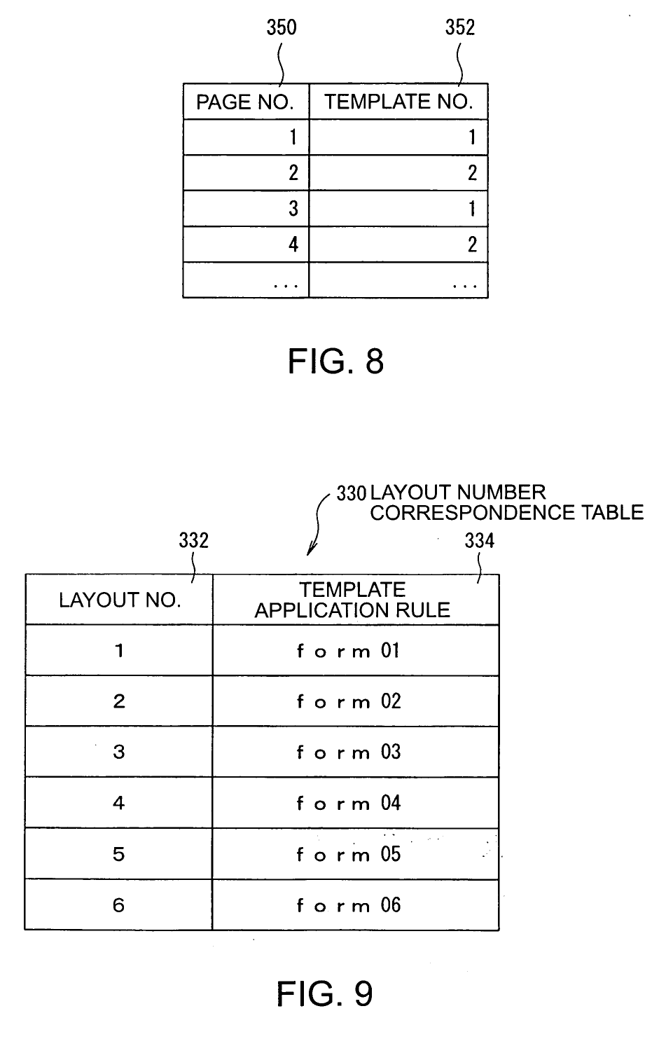

The template registration DB 42 stores a plurality of different template application rules form 01-form 06 as shown in FIG. 7. The structure of the template application rule will be discussed in detail with reference to FIGS. 7 and 8.

FIGS. 7 and 8 illustrate the data structure of the template application rule.

The template application rule defines the manner of applying the template to each layout area 360 when a layout result involves a plurality of layout areas 360. As shown in FIG. 8, a single record is registered for each page. Each record includes a field 350 to register a page number therein, and a field 352 to register a template number to identify a page template.

Referring to FIG. 8, “1” as a page number and “1” as a template number are registered in a first row record. This defines that the page template having the template number of “1” be applied to the layout area 360 of a top page.

As shown in FIG. 9, the template registration DB 42 stores a layout number correspondence table 330 listing the correspondence between the template application rules form 01-form 06 and the layout numbers. The structure of the layout number correspondence table 330 will be discussed in detail with reference to FIG. 9.

FIG. 9 shows the data structure of the layout number correspondence table 330.

As shown in FIG. 9, in the layout number correspondence table 330 one record is registered for a respective layout number. Each record includes a field 332 to register the layout number and a field 334 to register the template application rule.

In the example of FIG. 9, “1” as a layout number and “form 01” as a template application rule name are registered in a first row record, and “2” as a layout number and “form 02” as a template application rule name are registered in a second row record.

The data structure of the content registration DB 44 will now be discussed in detail with reference to the drawings.

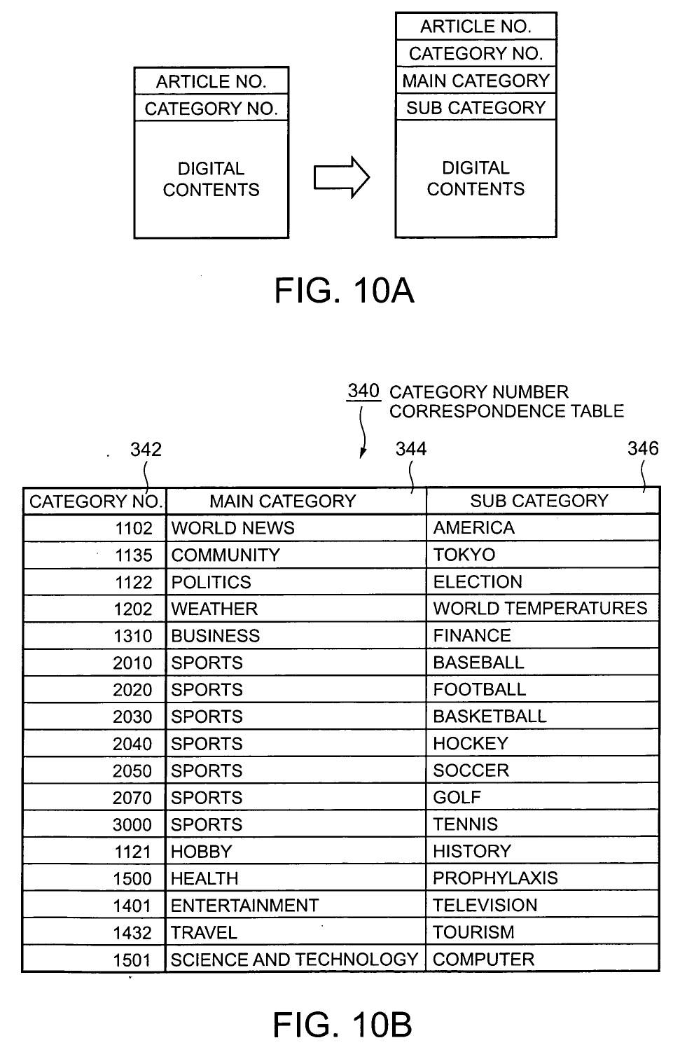

As shown in FIG. 10, the content registration DB 44 stores the digital contents supplied by the content providing terminals S1-Sn, and the category number correspondence table 340 listing the correspondence between a main category, a sub-category, and a category number.

FIG. 10 illustrates the data structure of the digital content and the category number correspondence table 340.

Each of the digital contents supplied by the content providing terminals S1-Sn has an article number and a category number attached thereto as illustrated in FIG. 10(A). The content delivery terminal 100 classifies the digital contents according to category number and then registers the classified digital contents onto the content registration DB 44. The content delivery terminal 100 references the category number correspondence table 340, thereby registering the digital contents with the main category and the sub-category attached thereto in addition to the article number and the category number during registration. The digital content contains, as a single article, title information representing a title of an article, image information relating to an image of the article, and text information relating to the text of the article.

Referring to FIG. 10(B), a single record is registered on a per main category basis and on a per sub-category basis in the category number correspondence table 340. Each record contains a field 342 to register a category number therein, a field 344 to register a main category therein and a field 346 to register a sub-category therein.

In the example of FIG. 10(B), a first row record registers “1102” as the category number, “WORLD NEWS” as the main category, and “AMERICA” as the sub-category therein, and a sixth row record registers “2010” as the category number, “SPORTS” as the main category, and “BASEBALL” as the sub-category therein.

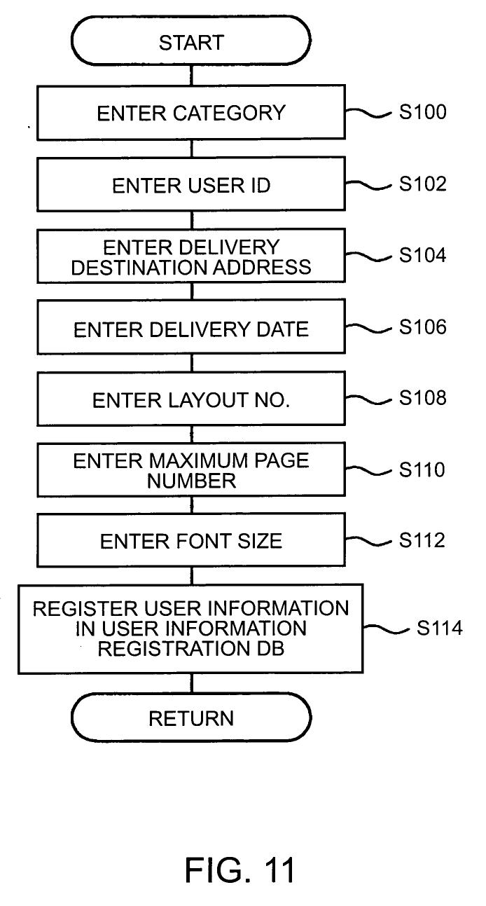

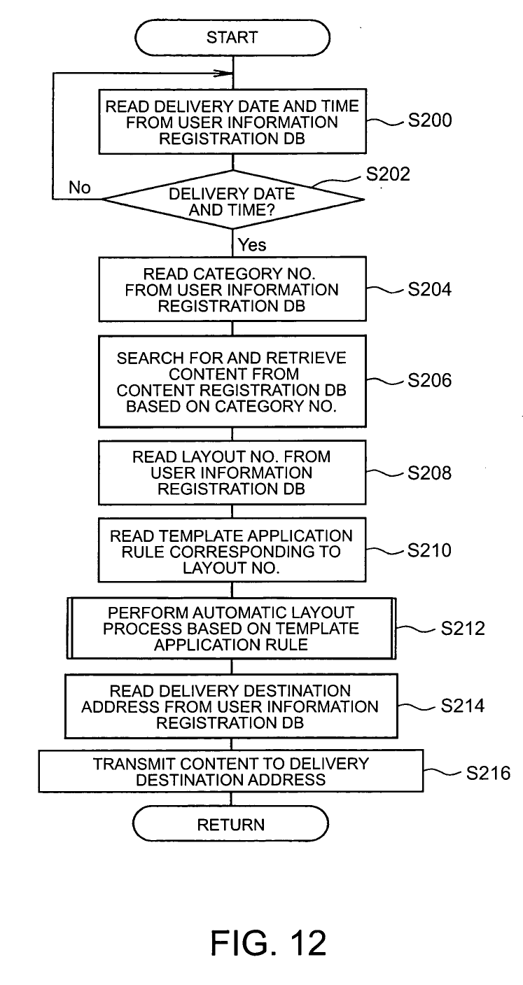

The structure of the CPU 30 and the process performed by the CPU 30 are described with reference to FIGS. 11 and 12.

The CPU 30, composed of a microprocessor unit MPU, etc., starts a predetermined program stored in a predetermined area of the ROM 32, and executes a user registration process and a content delivery process in a time division manner in flowcharts shown in FIGS. 11 and 12.

The user registration process is described first in detail with reference to FIG. 11.

FIG. 11 is the flowchart describing the user registration process. When a user has accessed the system, the CPU 30 requests the user to input the required user information, such as the user ID, and registers the input user information in the user profile table 300 in the user registration process. When the CPU 30 starts, the process starts with step S100 shown in FIG. 11. An input operation in each of the following steps is performed interactively with the user.

In step S100, the main category and the sub-category are input. In step S102, the user ID and the password are entered. In step S104, the destination address is input, and in step S106, the date and time of delivery are input, and the routine proceeds to step S108.

In step S108, the layout number is input. In step S110, the maximum number of pages is input. In step S112, the font size is input. The routine proceeds to step S114, where the CPU 30 registers user information input in steps S100-S112 in the user profile table 300. The CPU 30 ends the series of steps, and then returns to the original process.

Referring to FIG. 12, the content delivery process will be discussed in detail.

FIG. 12 is a flowchart showing the content delivery process. In the content delivery process, the user profile table 300 is referenced to deliver the digital content to the user terminal 200. The content delivery process is executed by the CPU 30. Referring to FIG. 12, the CPU 30 starts with step S200. The process of the following steps is performed for each record of the user profile table 300. In practice, each step is performed by the number of times equal to the number of records registered in the user profile table 300.

In step S200, the date and time of delivery are read from the user profile table 300. In step S202, the CPU 30 determines, from the read date and time of delivery, whether it is the day on which the digital content must be delivered. If the CPU 30 determines that it is the day on which the digital content must be delivered (i.e., yes), the routine proceeds to step S204, else (i.e., no) the routine loops to step S200.

In step S204, the CPU 30 reads the category number from the user profile table 300. In step S206, the CPU 30 searches for the digital content in the content registration DB 44 according to the read category number, and retrieves the digital content having a category number matching the read category number. The routine proceeds to step S208.

In step S208, the CPU 30 reads the layout number from the user profile table 300. In step S210, the CPU 30 references the layout number correspondence table 330, and reads the template application rule corresponding to the read layout number from the template registration DB 42. In step S212, the CPU 30 performs an automatic layout process in which the output layout of the digital content retrieved in step S206 is determined based on the read template application rule, and thereby the digital content to be provided is produced. The routine then proceeds to step S214.

In step S214, the CPU 30 reads the destination address from the user profile table 300. In step S216, the CPU 30 delivers the produced digital content to the read destination address. The CPU 30 ends the above series of process steps and returns to the original process.

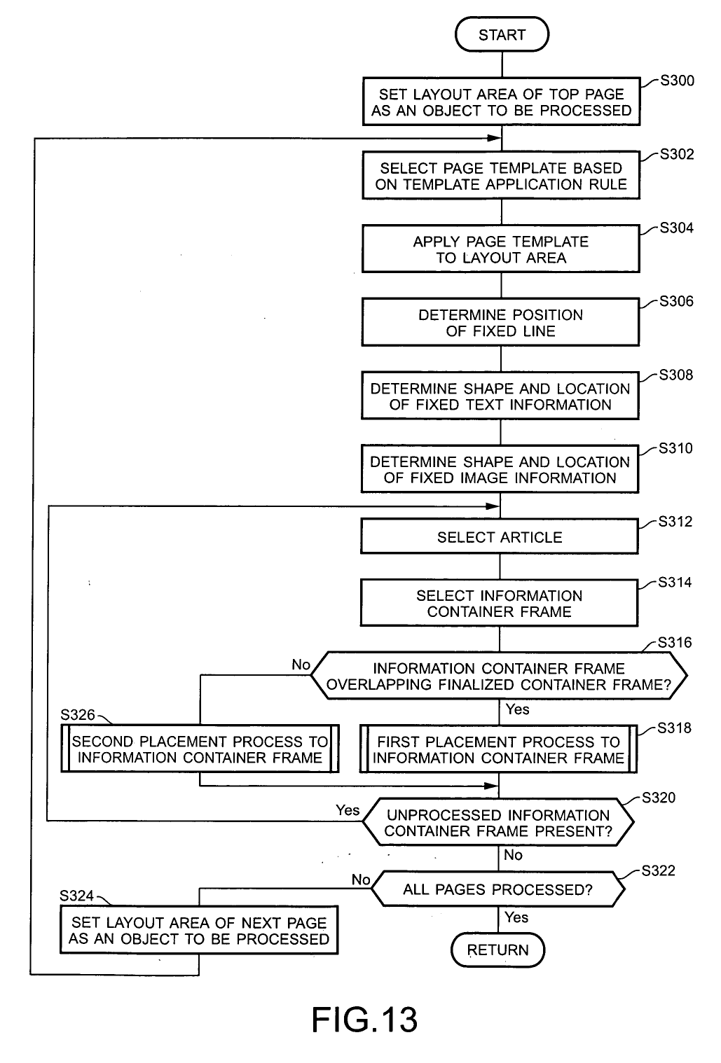

The automatic layout process in step S212 is discussed in detail with reference to FIG. 13.

FIG. 13 is a flowchart illustrating the automatic layout process.

When the automatic layout process is initiated in step S212, the process starts with step S300 as shown in FIG. 13.

In step S300, the CPU 30 sets the layout area 360 on the top page as an object to be processed. In step S302, the CPU 30 reads the page template from the template registration DB 42 based on the template application rule read in step S210. In step S304, the CPU 30 applies the read page template to the current layout area 360. The routine proceeds to step S306.

In step S306, the CPU 30 determines the location of a fixed line anchored to the page. In step S308, the CPU 30 determines the shape and location of the fixed text information anchored to the page. In step S310, the CPU 30 determines the shape and location of the fixed image information anchored to the page. The routine then proceeds to step S312.

In step S312, the CPU 30 selects an article to be placed in the layout area 360, from among the digital contents found in the search in step S206, according to the predetermined priority order. In step S314, the CPU 30 selects an information container frame from the layout area 360 which is currently to be processed (hereinafter a current layout area 360) according the predetermined priority order. The routine then proceeds to step S316.

In step S316, the CPU 30 determines whether an information container frame having an article placed therewithin and the location thereof finalized (hereinafter a finalized container frame) overlaps the information container frame selected in step S314 (hereinafter simply a selected information container frame). If it is determined that the finalized container frame overlaps the selected information container frame (i.e., yes), the routine proceeds to step S318. Otherwise, the routine proceeds to step S326. The CPU 30 performs a first placement process to place an article selected in step S312 (hereinafter simply referred to as a selected article) into the selected information container frame. The routine proceeds to step S320.

In step S320, the CPU 30 determines whether an unprocessed information container frame is present in the current layout area 360. If it is determined that no unprocessed information container frame is present (i.e., no), the routine proceeds to step S322. The CPU 30 determines whether an unposted article is present among the digital contents searched for and retrieved in step S206. If it is determined that no unposted article is present (i.e., no), the CPU 30 ends the series of steps, and return to the original process.

If it is determined in step S322 that an unposted article is present (i.e., yes), the routine proceeds to step S324. The layout area 360 of a next page is set as an object to be processed, and then the routine loops to step S302.

If it is determined in step S320 that an unprocessed information container frame is present in the current layout area 360 (i.e., yes), the routine loops to step S312.

If it is determined in step S316 that the finalized container frame does not overlap the selected information container frame (i.e., no), a second placement process to place the selected article into the selected information container frame is performed. The routine proceeds to step S320. Specifically, the second placement process for the information container frame is a process to place the selected article into the selected information container frame. The difference between the second placement process and the first placement process in step S318 is that, in the second placement process, the selected article is placed into the selected information container frame without segmenting the selected information container frame except when the selected information container frame is unable to accommodate the selected article.

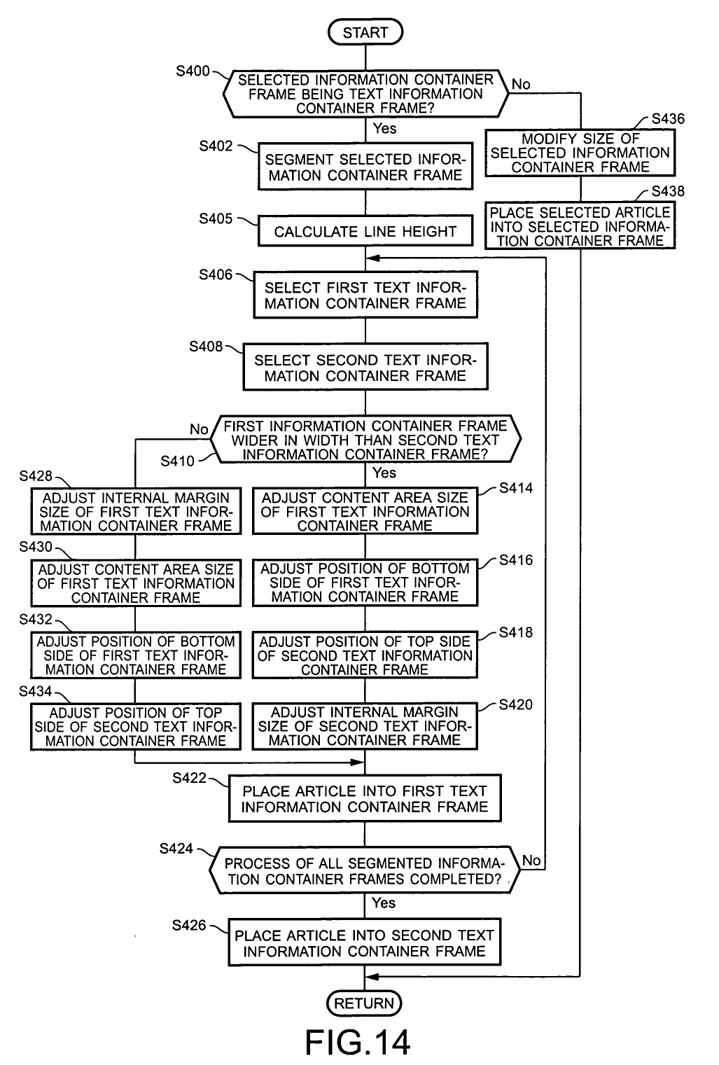

The first placement process to place the content into the information container frame in step S318 will now be discussed with reference to FIG. 14.

FIG. 14 is a flowchart of the first placement process to place the content into the information container frame.

The first placement process for the information container frame includes segmenting the text information container frame of the selected information container frames so that the text information container frame does not overlap the finalized container frame and placing the selected article into the segmented text information container frames in a continuous manner. When step S318 is initiated, the process starts with step S400 as shown in FIG. 14.

In step S400, the CPU 30 determines whether the selected information container frame is a text information container frame. If it is determined that the selected information container frame is a text information container frame (i.e., yes), the routine proceeds to step S402. The CPU 30 segments the selected information container frame so that the segmented text information container frames do not overlap the finalized container frame. The routine proceeds to step S405.

In step S405, line height lh is calculated based on the character height and line spacing designated in the segmented text information container frames (hereinafter segmented information container frames). The routine then proceeds to step S406.

In step S406, a first text information container frame is selected from a plurality of segmented text information frames. Specifically, in step S406, a segmented text information frame that will have to receive top text information of the selected article is selected as the first text information container frame from among the segmented text information frames, if none of the segmented text information frames has no article placed therewithin. If the article is placed in one of the information container frames, a information container frame, succeeding to the information container frame that has just received an article, is selected as the first text information container frame. An article to be placed into the first text information container frame is hereinafter referred to as a first split article.

In step S408, a second text information container frame is selected from among the plurality of segmented text information frames. Specifically, in step S408, a segmented text information frame that will have to receive a portion of the selected article following the first split article is selected from the information container frames having no article placed therewithin. One of the split articles to be placed into the second text information container frame is hereinafter referred to as a second split article.

The horizontal writing format is set in the first text information container frame and the second text information container frame. The positional relationship in the layout area 360 is that the second text information container frame is arranged below the first text information container frame. In other words, lines continue in proximity areas of the respective first text information container frame and second text information container frame.

In step S410, the CPU 30 determines whether the first text information container frame is wider in width (horizontal length) than the second text information container frame. If it is determined that the first text information container frame is wider than the second text information container frame (i.e., yes), the routine proceeds to step S414.

In step S414, the size of the content area of the first text information container frame is adjusted so that the line height of the first text information container frame equals lh. In step S416, the bottom side of the first text information container frame is adjusted in position. The routine proceeds to step S418.

In step S418, the top side of the second text information container frame is adjusted in position so that the top side of the second text information container frame is positioned at the upper edge of the internal margin of the bottom side of the first text information container frame. In step S420, the internal margin of the top side of the second text information container frame is set to be zero. In step S422, the first split article is placed into the first text information container frame. The routine proceeds to step S424.

In step S424, the CPU 30 determines whether all segmented information container frames have undergone steps S406-S422 and S428-S434. If it is determined that all segmented information container frames have undergone these steps (i.e., yes), the routine proceeds to step S426. The second split article is placed into the second text information container frame. The CPU 30 ends this series of steps, and returns to the original process.

If it is determined in step S424 that not all segmented information container frames have undergone steps S406-S422 and S428-S434 (i.e., no), the routine loops to step S406 to select the first text information container frame.

If it is determined in step S410 that the first text information container frame is equal to or narrower than the second text information container frame (i.e., no), the routine proceeds to step S428. In step S428, the internal margin size of the bottom side of the first text information container frame is set to be zero. In step S430, the size of the content area of the first text information container frame is adjusted so that the line height in the content area of the first text information container frame equals lh. The routine proceeds to step S432.

In step S432, the bottom side of the first text information container frame is adjusted in position so that the bottom side of the first text information container frame is positioned at the lower edge of the internal margin of the top side of the second text information container frame. In step S434, the top side of the second text information container frame is adjusted. The routine proceeds to step S422.

If it is determined in step S400 that the selected information container frame is not a text information container frame (i.e., no), the routine proceeds to step S436. The selected information container frame is modified in size not to overlap the finalized container frame. In step S438, the selected article is placed into the selected information container frame. The CPU 30 ends the series of steps, and returns to the original process.

The operation of the present exemplary embodiment will now be discussed.

The operation to register information required to deliver digital content will now be discussed.

When a user desires to receive digital content, the user accesses the content delivery terminal 100 using a WWW browser on the user terminal 200 and then inputs a user registration request.

When the user terminal 200 receives the user registration request, the user terminal 200 requests the user to input required user information in communication with the content delivery terminal 100. In response to the request, the user inputs, as the user information, a main category, a sub-category, a user ID, a password, a destination address, the date of delivery, the time of delivery, a layout number, the maximum number of pages, and a font size. The user information is then sent to the content delivery terminal 100.

Upon receiving the user information in response to the registration request, the content delivery terminal 100 registers the received user information in the user profile table 300 in process steps S100-S114.

The process of delivering a digital content referencing the user profile table 300 is discussed below.

If the content delivery terminal 100 determines that it is the day and time to deliver the digital content, by referencing the user profile table 300, the CPU 30 performs process steps S204 and S206. The CPU 30 therefore reads the category number from the user profile table 300 and searches for digital contents in the content registration DB 44, based on the read category number, thereby retrieving digital content having a category number matching the read category number. In process steps S208-S212, the CPU 30 reads a layout number from the user profile table 300, and references the layout number correspondence table 330, thereby reading a template application rule, corresponding to the read layout number, from the user information registration DB 40. The CPU 30 determines an output layout for the digital content based on the read template application rule and produces a digital content to be provided.

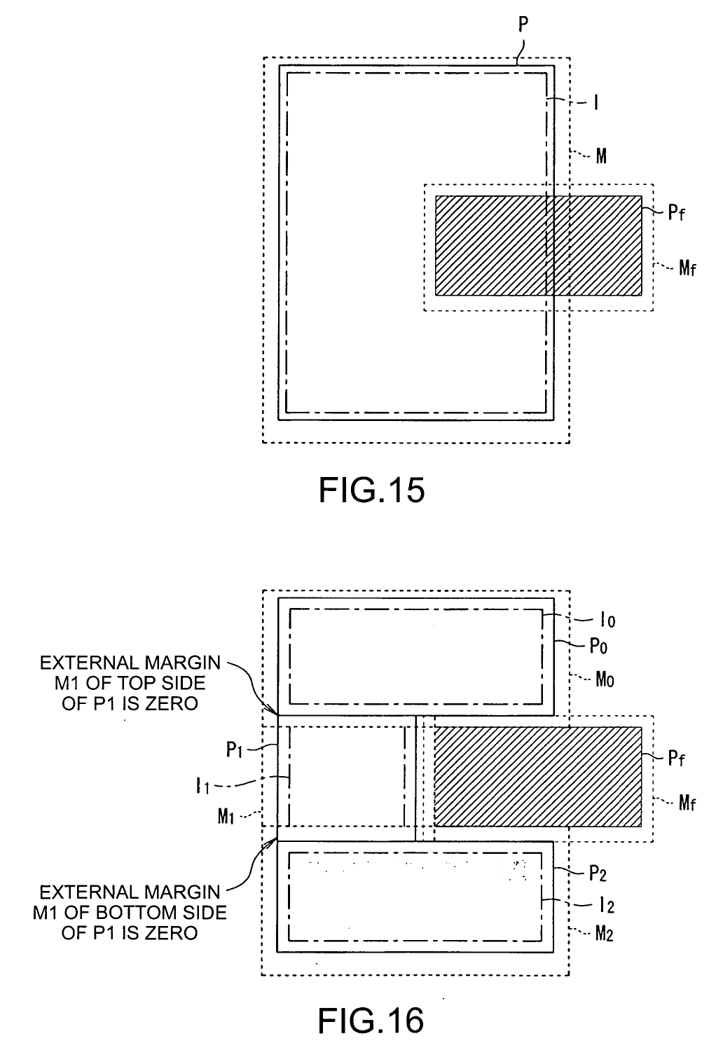

A layout process will now be discussed in detail with reference to FIGS. 15 through 19. In the layout process, the layout area 360 of a top page is set as an object to be processed in steps S300-S304. A page template is read from the template registration DB 42 according to the read template application rule. The read page template is applied to the current layout area 360. In steps S306-S310, the location of a fixed line, the shape and location of fixed text information, and the shape and location of fixed image information are determined in that order.

FIG. 15 illustrates a layout state in which information container frames overlap each other.

As shown in FIG. 15, a finalized container frame Pf overlaps a text information container frame P. In the case of FIG. 15, a center right portion of the text information container frame P overlaps a left half portion of the finalized container frame Pf. As shown in FIG. 15, M and I respectively represent an external margin M and an internal margin I of the text information container frame P. Mf represents an external margin of the finalized container frame Pf.

Let (Pt, Pb, Pl, Pr) represent the placement location of the text information container frame P, and let (Pft, Pfb, Pfl, Pfr) represent the placement location of the finalized container frame Pf. Pt is a Y coordinate of the top side of the text information container frame P. Pb is a Y coordinate of the bottom side of the text information container frame P, Pl is an X coordinate of the left side of the text information container frame P. Pr is an X coordinate of the right side of the text information container frame P. Pft, Pfb, Pfl, and Pfr represent respective coordinates of the finalized container frame Pf.

Let (Mt, Mb, Ml, Mr) represent the external margin M, and let (Mft, Mfb, Mfl, Mfr) represent the external margin Mf. Mt represents the length from top side to the upper edge of the top-side external margin of the text information container frame P, Mb represents the length from the bottom side to the lower edge of the bottom-side external margin of the text information container frame P. Ml represents the length from the left side to the left edge of the left-side external margin of the text information container frame P. Mr represents the length from the right side to the right edge of the right-side external margin of the text information container frame P. Mft, Mfb, Mfl, and Mfr also represent respective lengths of the finalized container frame Pf.

The internal margin I is represented by (It, Ib, Il, Ir). Here, It represents the length from the top side to the lower edge of the top-side internal margin of the text information container frame P, Ib represents the length from the bottom side to the upper edge of the bottom-side internal margin of the text information container frame P, Il represents the length from the left side to the right edge of the left-side internal margin of the text information container frame P, and Ir represents the length from the right side to the left edge of the right-side internal margin.

In this overlapping state, articles to be placed into the layout area 360 are selected from the digital contents and retrieved in step S206 according to a predetermined priority order in steps S312 and S314. The text information container frame P is selected from the layout area 360.

FIG. 16 illustrates the layout state in which the text information container frame P is segmented. As shown in the layout shown in FIG. 15, the text information container frame P is segmented not to overlap the finalized container frame Pf in steps S400 and S402. Specifically, the text information container frame P is segmented into three text information container frames P0, P1, and P2 as shown in FIG. 16. The text information container frame P1 and the finalized container frame Pf are juxtaposed with the top edges thereof horizontally aligned and the bottom edges thereof horizontally aligned. The text information container frame P0 is arranged above the text information container frame P1 and the finalized container frame Pf. The text information container frame P2 is arranged below the text information container frame P1 and the finalized container frame Pf. Each of the text information container frames P0 and P2 are wider in width than the text information container frame P1. The selected article is placed into the text information container frames P0, P1, and P2 in a horizontal writing format in that order.

When the text information container frame P is segmented into the three text information container frames P0, P1, and P3 in this way, external margins M0-M2 are respectively defined outside the segmented text information container frames P0, P1, and P2. Internal margins I0-M2 are respectively defined inside the segmented text information container frames P0, P1, and P2. As shown in FIG. 16, the external margins M1 of the top side and the bottom side of the text information container frame P1 in the middle position are respectively set to be zero. The top side of the text information container frame P1 is put into direct contact with the bottom side of the text information container frame P0 and the bottom side of the text information container frame P1 is put into direct contact with the top side of the text information container frame P2.

As shown, a portion of the top side of the external margin Mf of the finalized container frame Pf joins a portion of the bottom side of the external margin M0 of the text information container frame P0. The left side of the external margin Mf of the finalized container frame Pf joins the right side of the external margin Ml of the text information container frame P1. A portion of the bottom side of the external margin Mf of the finalized container frame Pf joins a portion of the top side of the external margin M2 of the text information container frame P2.

In step S405, the line height lh of each of the text information container frames P0-P2 is calculated based on a character height and a line spacing designated in the text information container frame.

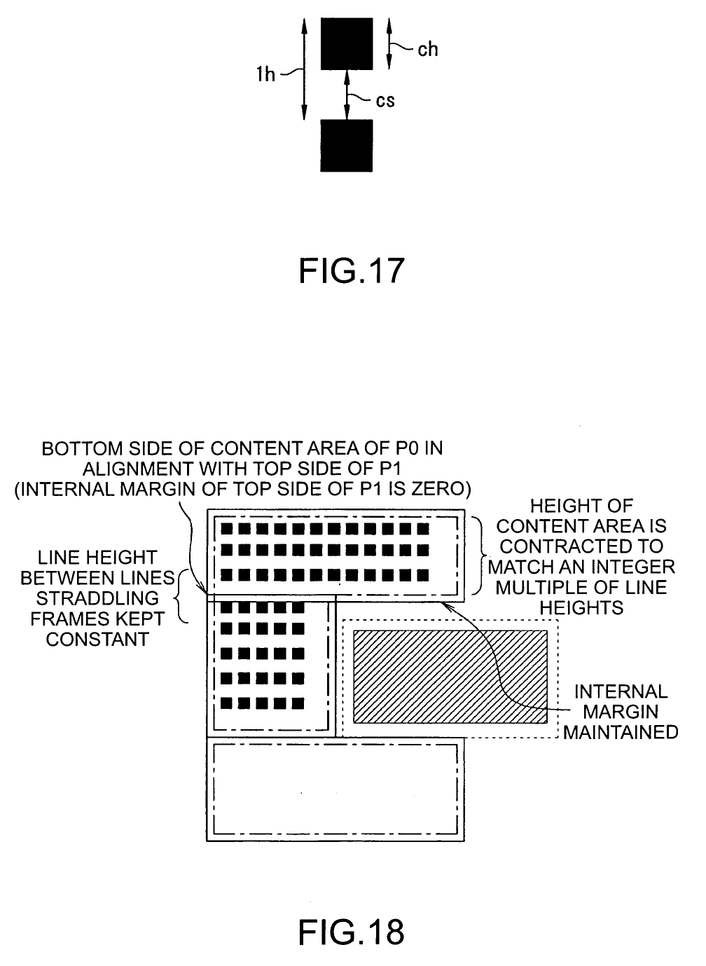

FIG. 17 illustrates how the line height lh is calculated. As shown, the line height lh is calculated from the character height ch, and the line spacing cs as expressed in equation (1).

lh=ch+cs (1)

The margin sizes and the placement locations of the text information container frames P0 and P1 are adjusted as shown in FIG. 18. Referring to FIG. 18, the text information container frame P0 is selected as the first text information container frame in step S406. The text information container frame P1 is selected as the second text information container frame in step S408.

Since the text information container frame P0 is wider in width than the text information container frame P1, the size of the content area of the text information container frame P0 is adjusted in step S414 so that the line height of the content area of the text information container frame P0 becomes lh. Let (P0t, P0b, P0l, P0r) represent the placement location of the text information container frame P0 and let (I0t, I0b, I0l, I0r) represent the internal margin I0 of the text information container frame P0. The height h0 of the content area of the text information container frame P0 is calculated using equation (2). The size of the content area of the text information container frame P0 is adjusted until the height of the content area of the text information container frame P0 is h0.

h0=(P0b−P0t−I0t−I0b)/lh×lh (2)

In equation (2), (P0b−P0t−I0t−I0b)/lh is calculated as an integer with the fraction part rounded down. The reason is that an increase in the height of the content area of the text information container frame P0 may lead to overlapping the finalized container frame Pf, and by rounding down the fraction part, in other words, by not increasing the height, the possibility of overlapping the finalized container frame Pf is reduced.

In step S416, the bottom side of the text information container frame P0 is adjusted in position. The position P0b′ of the bottom side of the text information container frame P0 is calculated using equation (3).

P0b′=P0t+I0t+ho+I0b (3)

In step S418, the top side of the text information container frame P1 is adjusted in position so that the top side of the text information container frame P1 is positioned at the upper edge of the bottom-side internal margin of the text information container frame P0.

The position P1t′ of the top side of the text information container frame P1 is calculated from equation (4).

P1t′=P0t+I0t+ho (4)

In steps S420 and S422, the size of the top-side internal margin of the text information container frame P1 is set to be zero. The first split article is placed into the text information container frame P0.

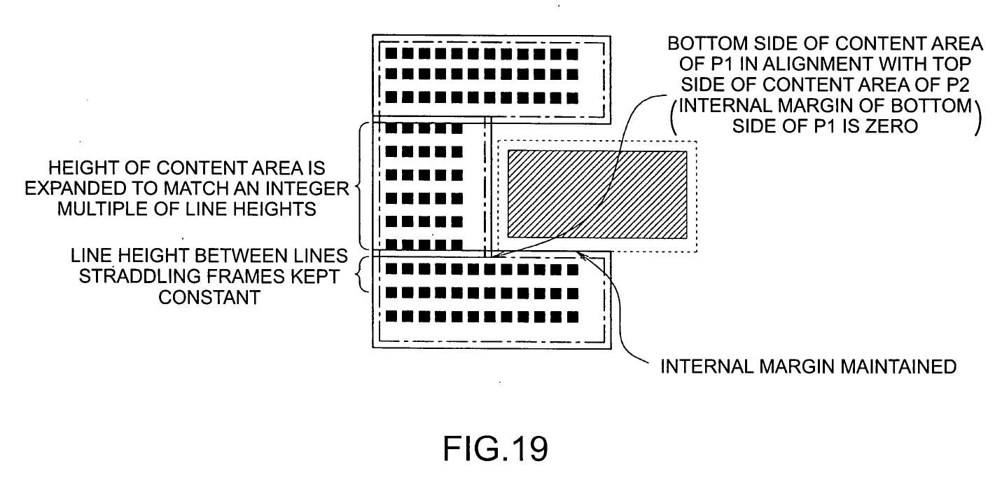

The margin sizes and the placement locations of the text information container frames P1 and P2 are adjusted as shown in FIG. 19.

As shown in FIG. 19, the text information container frame P1 is selected as the first text information container frame in step S406 and the text information container frame P2 is selected as the second text information container frame in step S408.

Since the text information container frame P1 is narrower in width than the text information container frame P2. In steps S428 and S430, the size of the bottom-side internal margin of the text information container frame P1 is set to be zero. The size of the content area of the text information container frame P1 is adjusted so that the line height of the content area of the text information container frame P1 is set to lh. Let (P1t, P1b, P1l, P1r) represent the placement position of the text information container frame P1. Let (I1t, I1b, I1l, I1r) represent the internal margin I1 of the text information container frame P1. Let (I2t, I2b, I2l, I2r) represent the internal margin I2 of the text information container frame P2. The height h1 of the text information container frame P1 is calculated from equation (5). The size of the content area of the text information container frame P1 is adjusted so that the height of the content area of the text information container frame P1 is h1.

h1=(P1b−P1t−I1t−I2t)/lh×lh (5)

In equation (5), (P1b−P1t−I1t−I1t)/lh is calculated as an integer with the tenths place rounded up. The reason is that an increase in the height of the content area of the text information container frame P1 does not lead to overlapping the finalized container frame Pf. By rounding up the tenths place, in other words, by increasing the height, the possibility of overlapping the finalized container frame Pf is reduced.

In step S432, the bottom side of the text information container frame P1 is adjusted in position so that the bottom side of the text information container frame P1 is positioned at the lower edge of the top-side internal margin of the text information container frame P2.

The position P1b′ of the bottom side of the text information container frame P1 is calculated from the following equation (6).

P1b′=P1t+I1t+h1 (6)

In step S434, the top side of the text information container frame P2 is adjusted in position. The position P2t′ of the top side of the text information frame P2 is calculated from equation (7).

P2t′=P1t+I1t+h1−I2t (7)

The first split article is placed into the text information container frame P1 in step S422 and the second split article is placed into the text information container frame P2 in step S426.

If the selected information container frame is an information container frame, such as an image information container frame, other than the text information container frame, the size of the selected information container frame is modified in step S436 so that the selected information container frame does not overlap the finalized container frame. The selected article is placed into the selected information container frame in step S438.

The article is placed into the layout area 360 of all pages, and the output layout of the digital content is determined. A destination address is read from the user profile table 300 in step S214. The produced digital content is sent to the read destination address in step S216.

When the selected article is placed in a consecutive manner into a plurality of text information container frames arranged in proximity in the present exemplary embodiment, the content delivery terminal 100 adjusts the size of the margin and the placement location of one of the plurality of text information container frames so that the spacing between two text information container frames having consecutive lines in the proximity areas thereof is equal or substantially equal to the line height in each of the text information container frames.

In this way, the spacing between the text information container frames and the line height in each of the text information container frames are adjusted by modifying the size of the margin and the placement location of the text information container frame. Even if the margin of the text information container frame is set to be larger than the desired line height, the spacing between the text information container frames and the line height in each text information container frame are set to be substantially constant. Even if the margin is set in the text information container frame, a relatively aesthetically appealing layout is provided in comparison with the related art.

In accordance with the present exemplary embodiment, the content delivery terminal 100 segments one text information container frame overlapping another information container frames so that none of the text information container frames overlaps each other, and adjusts the size of the margin and the placement location of one of the plurality of segmented text information container frames so that the spacing between two text information container frames having consecutive lines in the proximity areas thereof is equal or substantially equal to the line height in each of the two text information container frames. The content delivery terminal 100 places the selected post information into the segmented text information container frames in a continuous manner.

When one text information container frame overlaps another information container frame depending on the content of the post information, the amount of the post information, the logical structure of the post information, etc., the one text information container frame is segmented to resolve the overlapping state. Subsequent to the segmentation, the spacing between the text information container frames and the line height in each of the text information container frames are set to be substantially constant. Even if the text information container frame overlaps the other information container frame, a relatively aesthetically appealing layout is thus provided.

If the first text information container frame is wider in width than the second text information container frame, the content delivery terminal 100 in the present exemplary embodiment sets the size of the internal margin of the top side of the second text information container frame to zero, and adjusts the placement location of the second text information container frame so that the top side of the second text information container frame is positioned at the upper edge of the internal margin of the bottom side of the first text information container frame.

As for the text information container frames P0 and P1 shown in FIG. 15, the text information container frame P1 is moved upward to join the text information container frame P0. This arrangement reduces the possibility that the text information container frames P0 and P1 join the finalized container frame Pf. An even more aesthetically appealing layout is provided.

If the first text information container frame is narrower in width than the second text information container frame, the content delivery terminal 100 in the present exemplary embodiment sets the size of the internal margin of the bottom side of the first text information container frame to zero, and adjusts the placement location of the first text information container frame so that the bottom side of the first text information container frame is positioned at the lower edge of the internal margin of the top side of the second text information container frame.

As for the text information container frames P1 and P2 shown in FIG. 15, the text information container frame P1 is moved downward to join the text information container frame P2. This arrangement reduces the possibility that the text information container frames P1 and P2 join the finalized container frame Pf. An even more aesthetically appealing layout is provided.

The content delivery terminal 100 in the present exemplary embodiment searches for and retrieves the digital content from the content registration DB 44 based on the user information in the user registration DB 40.

Since the information unique to the user and the information designated by the user are referenced in the selection of the digital content, the available digital content having a content generally faithfully reflecting the user's desire is produced.

In accordance with the present exemplary embodiment, the content delivery terminal 100 produces an available digital content by determining an output layout of the digital content based on the user information in the user information registration DB 40.

Since the information unique to the user and the information designated by the user are referenced in the determination of the digital content, the available digital content generally faithfully reflecting the user's desire is produced.

In accordance with the present exemplary embodiment, present invention adjusts the size of the internal margin I. The external margin M alone or the external margin M together with the internal margin I may be adjusted depending on the size (width) of the internal margin I and character spacing.

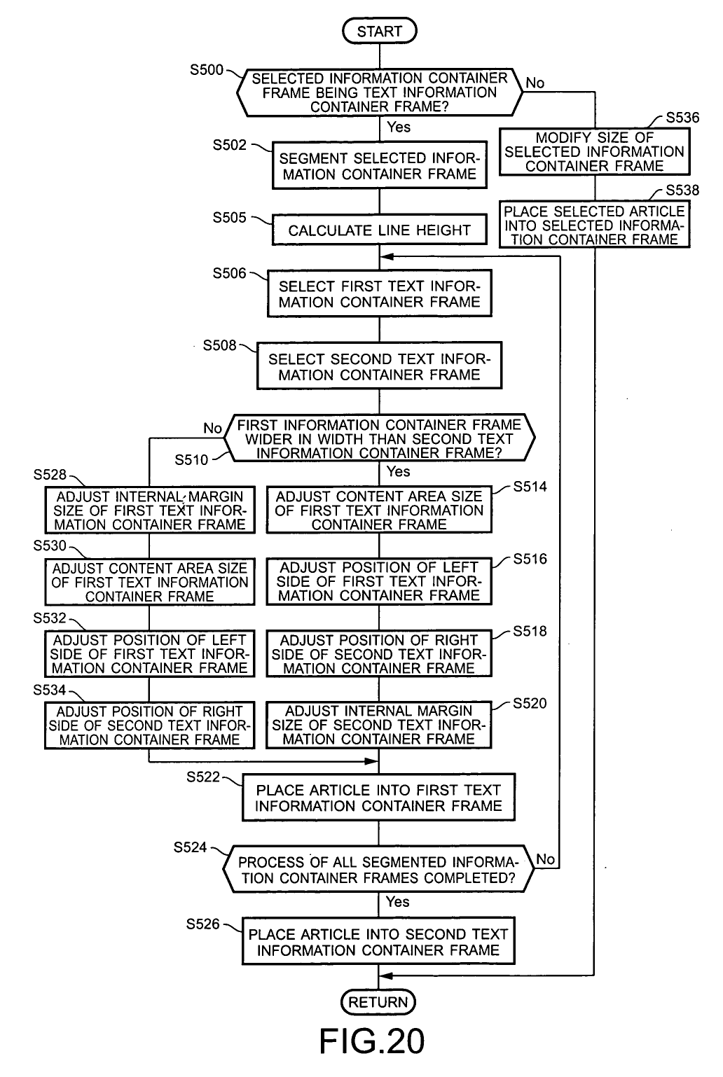

A second exemplary embodiment of the present invention will now be discussed with reference to the drawings. FIGS. 20 through 23 illustrate a layout system, a layout program, and a layout method in accordance with the second exemplary embodiment of the present invention. In the discussion that follows, only the difference of the second exemplary embodiment from the first exemplary embodiment is discussed, and like elements are identified with like reference numerals, and the discussion thereof is omitted here.

The layout system, the layout program, and the layout method in accordance with the second exemplary embodiment of the present invention are applied to a system in which the content delivery terminal 100 delivers a digital content, such as news, to the user terminal 200. The difference between the first exemplary embodiment and the second exemplary embodiment is that a vertical writing format is set in the text information container frame, and that text information is placed in the vertical writing format into the text information container frame. The vertical writing format here proceeds from right to left columns in the second exemplary embodiment. However, the present exemplary embodiment is applicable to the vertical writing format that proceeds from left to right columns.

The CPU 30 executes a first placement process to place the digital content to the text information frame as illustrated in FIG. 20, instead of the first placement process for the placing the digital content to the information container frame as illustrated in FIG. 14.

FIG. 20 is a flowchart of the first placement process for the information container frame.

The first placement process for the information container frame includes segmenting the text information container frame of the selected information container frames so that the text information container frame does not overlap the finalized container frame, and placing the selected article into the segmented text information container frames in a continuous manner. When step S318 is initiated, the process starts with step S500, as shown in FIG. 20.

In step S500, the CPU 30 determines whether the selected information container frame is a text information container frame. If it is determined that the selected information container frame is a text information container frame (i.e., yes), the routine proceeds to step S502. The CPU 30 segments the selected information container frame so that the segmented text information container frames do not overlap the finalized container frame. The routine proceeds to step S505.

In step S505, line height lh is calculated based on the character width and line spacing designated in the segmented information container frames. The routine then proceeds to step S506.

In step S506, a first text information container frame is selected from among a plurality of segmented information frame. In step S508, a second text information container frame is selected from among the plurality of segmented information frames. The manner of selecting the first text information container frame and the second text information container frame is identical to the one already discussed in connection with steps S406 and S408 in the first exemplary embodiment of the present invention.

The vertical writing format is set in the first text information container frame and the second text information container frame. The positional relationship in the layout area 360 is that the second text information container frame is arranged on the left-hand side of the first text information container frame. In other words, lines continue in proximity areas of the respective first text information container frame and the second text information container frame.

In step S510, the CPU 30 determines whether the first text information container frame is longer (in vertical length) than the second text information container frame. If it is determined that the first text information container frame is longer than the second text information container frame (i.e., yes), the routine proceeds to step S514.

In step S514, the size of the content area of the first text information container frame is adjusted so that the line height of the first text information container frame equals lh, and in step S516, the left side of the first text information container frame is adjusted in position. The routine proceeds to step S518.

In step S518, the right side of the second text information container frame is adjusted in position so that the right side of the second text information container frame is positioned at the right edge of the internal margin of the left side of the first text information container frame. In step S520, the internal margin of the right side of the second text information container frame is set to be zero. In step S522, the first split article is placed into the first text information container frame. The routine proceeds to step S524.

In step S524, the CPU 30 determines whether all segmented information container frames have undergone steps S506-S522 and S528-S534. If it is determined that all segmented information container frames have undergone these steps (i.e., yes), the routine proceeds to step 526. The second split article is placed into the second text information container frame. The CPU 30 ends this series of steps, and returns to the original process.

If it is determined inn step S524 that not all segmented information container frames have undergone steps S506-S522 and S528-S534 (i.e., no), the routine proceeds to step S506 to select a first text information container frame.

If it is determined in step S510 that the first text information container frame is equal to or shorter in vertical length than the second text information container frame (i.e., no), the routine proceeds to step S528. In step S528, the internal margin size of the left side of the first text information container frame is set to be zero. In step S530, the size of the content area of the first text information container frame is adjusted so that the line height in the content area of the first text information container frame equals lh. The routine proceeds to step S532.

In step S532, the left side of the first text information container frame is adjusted so that the left side of the first text information container frame is positioned at the left edge of the internal margin of the right side of the second text information container frame. In step S534, the right side of the second text information container frame is adjusted. The routine proceeds to step S522.

If it is determined in step S500 that the selected information container frame is not a text information container frame (i.e., no), the routine proceeds to step S536. The selected information container frame is modified in size not to overlap the finalized container frame. In step S538, the selected article is placed into the selected information container frame. The CPU 30 ends the series of steps, and returns to the original process.

The operation of the present exemplary embodiment will now be discussed.

In the layout process, the layout area 360 of a top page is set as an object to be processed in steps S300-S304. A page template is read from the template registration DB 42 according to the read template application rule. The read page template is applied to the current layout area 360. In steps S306-S310, the location of a fixed line, the shape and location of fixed text information, and the shape and location of fixed image information are determined in that order.

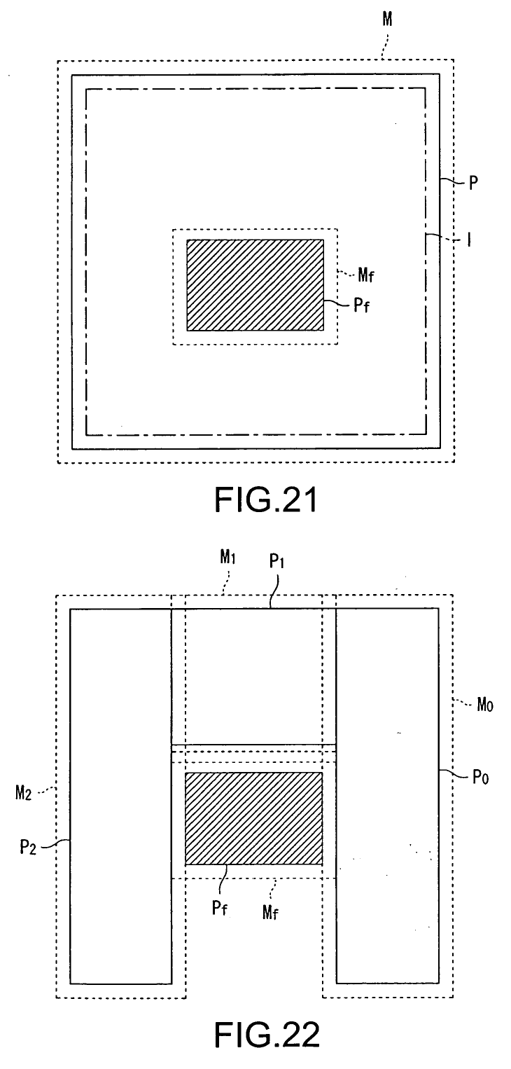

FIG. 21 illustrates a layout state in which information container frames overlap each other.

As shown in FIG. 21, a finalized container frame Pf overlaps a text information container frame P. In the case of FIG. 21, a center portion of the text information container frame P overlaps a finalized container frame Pf. As shown in FIG. 21, M and I respectively represent an external margin M and an internal margin I of the text information container frame P, and Mf represents an external margin of the finalized container frame Pf.

Let (Pt, Pb, Pl, Pr) represent the placement location of the text information container frame P, and let (Pft, Pfb, Pfl, Pfr) represent the placement location of the finalized container frame Pf. Pt is a Y coordinate of the top side of the text information container frame P. Pb is a Y coordinate of the bottom side of the text information container frame P, Pl is an X coordinate of the left side of the text information container frame P. Pr is an X coordinate of the right side of the text information container frame P. Pft, Pfb, Pfl, and Pfr represent respective coordinates of the finalized container frame Pf.

Let (Mt, Mb, Ml, Mr) represent the external margin M, and let (Mft, Mfb, Mfl, Mfr) represent the external margin Mf. Mt represents the length from top side to the upper edge of the top-side external margin of the text information container frame P, Mb represents the length from the bottom side to the lower edge of the bottom-side external margin of the text information container frame P. Ml represents the length from the left side to the left edge of the left-side external margin of the text information container frame P. Mr represents the length from the right side to the right edge of the right-side external margin of the text information container frame P. Mft, Mfb, Mfl, and Mfr also represent respective sizes of the margins of the finalized container frame Pf.

The internal margin I is represented by (It, Ib, Il, Ir). Here, It represents the length from the top side to the lower edge of the top-side internal margin of the text information container frame P. Ib represents the length from the bottom side to the upper edge of the bottom-side internal margin of the text information container frame P. Il represents the length from the left side to the right edge of the left-side internal margin of the text information container frame P. Ir represents the length from the right side to the left edge of the right-side internal margin.

In this overlapping state, articles to be placed into the layout area 360 are selected from the digital contents, searched for and retrieved in step S206 according to a predetermined priority order, in steps S312 and S314. The text information container frame P is selected from the layout area 360 of the text information container frame P.

FIG. 22 illustrates the layout state in which the text information container frame P is segmented.

As shown in the layout in FIG. 21, the text information container frame P is segmented not to overlap the finalized container frame Pf in steps S500 and S502. Specifically, the text information container frame P is segmented into three text information container frames P0, P1, and P2 as shown in FIG. 22. The text information container frame P1 and the finalized container frame Pf are arranged one above the other with the right edges thereof vertically aligned and the left edges thereof vertically aligned. The text information container frame P0 is arranged on the right-hand side of the text information container frame P1 and the finalized container frame Pf. The text information container frame P2 is arranged on the left-hand side of the text information container frame P1. The finalized container frame Pf. Each of the text information container frames P0 and P2 is longer in vertical length than the text information container frame P1, and the selected article is continuously placed into the text information container frames P0, P1, and P2 in a vertical writing format in that order.

In step S505, the line height lh of each of the text information container frames P0-P2 is calculated based on a character width and a line spacing designated in the text information container frame.

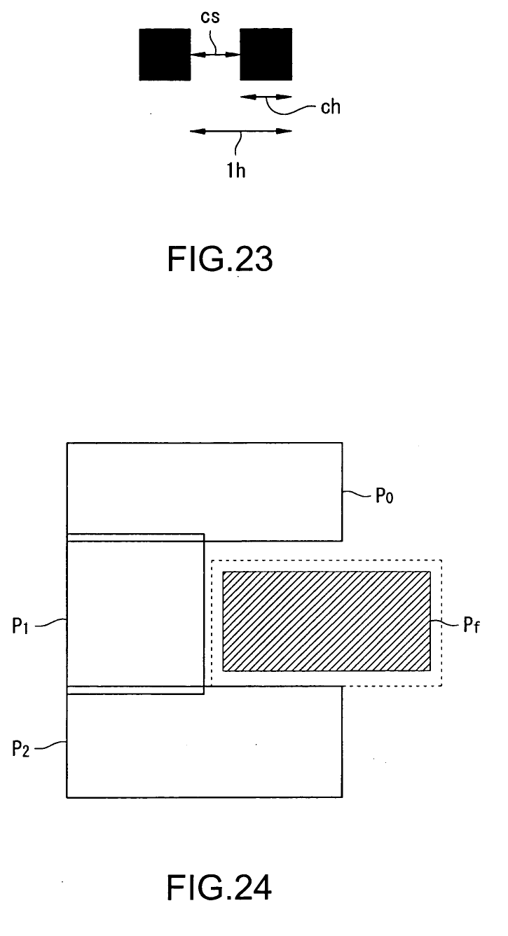

FIG. 23 illustrates how the line height lh is calculated. As shown, the line height lh is calculated from the character width ch, and the line spacing cs as expressed in equation (8).

lh=ch+cs (8)

The text information container frame P0 is selected as the first text information container frame in step S506, and the text information container frame P1 is selected as the second text information container frame in step S508.

Since the text information container frame P0 is longer in vertical length than the text information container frame P1, the size of the content area of the text information container frame P0 is adjusted in step S514 so that the line height of the content area of the text information container frame P0 is lh. Let (P0t, P0b, P0l, P0r) represent the placement location of the text information container frame P0 and let (I0t, I0b, I0l, I0r) represent the internal margin 10 of the text information container frame P0, and the width w0 of the content area of the text information container frame P0 is calculated using equation (9). The size of the content area of the text information container frame P0 is adjusted until the width of the content area of the text information container frame P0 becomes w0.

w0=(P0r−P0−I0r−I0l)/lh×lh (9)

In equation (9), (P0r−P0−I0r−I0l)/lh is calculated as an integer with the fraction part rounded down. The reason is that an increase in the width of the content area of the text information container frame P0 may lead to overlapping the finalized container frame Pf, and by rounding down the fraction part, in other words, by not expanding the width, the possibility of overlapping the finalized container frame Pf is reduced.

In step S516, the left side of the text information container frame P0 is adjusted in position. The position P0l′ of the left side of the text information container frame P0 is calculated using equation (10).

P0l′=P0r−I0r−I0l−wo (10)

In step S518, the right side of the text information container frame P1 is adjusted in position so that the right side of the text information container frame P1 is positioned at the right edge of the left-side internal margin of the text information container frame P0.

The position P1r′ of the right side of the text information container frame P1 is calculated from equation (11).

P1r′=P0r−I0r−wo (11)

In steps S520 and S522, the size of the right-side internal margin of the text information container frame P1 is set to be zero and the first split article is placed into the text information container frame P0.

The text information container frame P1 is selected as the first text information container frame in step S506 and the text information container frame P2 is selected as the second text information container frame in step S508.

Since the text information container frame P1 is shorter in vertical height than the text information container frame P2. In steps S528 and S530, the size of the left-side internal margin of the text information container frame P1 is set to be zero and the size of the content area of the text information container frame P1 is adjusted so that the line height of the content area of the text information container frame P1 is set to lh. Let (P1t, P1b, P1l, P1r) represent the placement position of the text information container frame P1, let (I1t, I1b, I1l, I1r) represent the internal margin I1 of the text information container frame P1, and let (I2t, I2b, I2l, I2r) represent the internal margin I2 of the text information container frame P2. The width w1 of the text information container frame P1 is calculated from equation (12). The size of the content area of the text information container frame P1 is adjusted so that the width of the content area of the text information container frame P1 is w1.

w1=(P1r−P1l−I1r+I2l)/lh×lh (12)

In equation (12), (P1r−P1l−I1r+I2l)/lh is calculated as an integer with the tenths place rounded up. The reason is that an increase in the width of the content area of the text information container frame P1 does not lead to overlapping the finalized container frame Pf, and by rounding up the tenths place, in other words, by expanding the width, the possibility of overlapping the finalized container frame Pf is reduced.

In step S532, the left side of the text information container frame P1 is adjusted in position so that the left side of the text information container frame P1 is positioned at the left edge of the right-side internal margin of the text information container frame P2.

The position P1l′ of the left side of the text information container frame P1 is calculated from the following equation (13).

P1l′=P1r−w1−I1r (13)

In step S534, the right side of the text information container frame P2 is adjusted in position. The position P2r′ of the right side of the text information frame P2 is calculated from equation (14).

P2r′=P1r−w1−I1r+I2r (14)

The first split article is placed into the text information container frame P1 in step 522 and the second split article is placed into the text information container frame P2 in step S526.

The article is placed into the layout areas 360 of all pages, and the output layout of the digital content is determined. A destination address is read from the user profile table 300 in step S214. The produced digital content is sent to the read destination address in step S216.

When the selected article is placed into a plurality of text information container frames arranged in proximity in the present exemplary embodiment, the content delivery terminal 100 adjusts the size of the margin and the placement location of one of the plurality of text information container frames so that the spacing between two text information container frames having consecutive lines in the proximity areas thereof is equal or substantially equal to the line height in each of the text information container frames.

In this way, the spacing between the text information container frames and the line height in each of the text information container frames are adjusted by modifying the size of the margin and the placement location of the text information container frame. Even if the margin of the text information container frame is set to be larger than the desired line height, the spacing between the text information container frames and the line height in each text information container frame are set to be substantially constant. Even if the margin is set in the text information container frame, a generally aesthetically appealing layout is provided in comparison with the related art.

In accordance with the present exemplary embodiment, the content delivery terminal 100 segments one text information container frame overlapping another information container frames so that none of the text information container frames overlaps each other, and adjusts the size of the margin and the placement location of one of the plurality of segmented text information container frames so that the spacing between two text information container frames having consecutive lines in the proximity areas thereof is equal or substantially equal to the line height in each of the two text information container frames. The content delivery terminal 100 places the selected post information into the segmented text information container frames in a continuous manner.

When one text information container frame overlaps another information container frame depending on the content of the post information, the amount of the post information, the logical structure of the post information, etc., the one text information container frame is segmented to resolve the overlapping state. Subsequent to the segmentation, the spacing between the text information container frames and the line height in each of the text information container frames are set to be substantially constant. Even if the text information container frame overlaps the other information container frame, a relatively aesthetically appealing layout is thus achieved.

If the first text information container frame is longer in vertical length than the second text information container frame, the content delivery terminal 100 in the present exemplary embodiment sets the size of the internal margin of the right side of the second text information container frame to zero, and adjusts the placement location of the second text information container frame so that the right side of the second text information container frame is positioned at the right edge of the internal margin of the left side of the first text information container frame.

As for the text information container frames P0 and P1 shown in FIG. 21, the text information container frame P1 is moved rightward to join the text information container frame P0. This arrangement reduces the possibility that the text information container frames P0 and P1 join the finalized container frame Pf. An even more aesthetically appealing layout is provided.

If the first text information container frame is shorter in vertical length than the second text information container frame, the content delivery terminal 100 in the present exemplary embodiment sets the size of the internal margin of the left side of the first text information container frame to zero, and adjusts the placement location of the first text information container frame so that the left side of the first text information container frame is positioned at the left edge of the internal margin of the right side of the second text information container frame.

As for the text information container frames P1 and P2 shown in FIG. 21, the text information container frame P1 is moved leftward to join the text information container frame P2. This arrangement reduces the possibility that the text information container frames P1 and P2 join the finalized container frame Pf. An even more aesthetically appealing layout is provided.

The content delivery terminal 100 in the present exemplary embodiment searches for and retrieves the digital content from the content registration DB 44 based on the user information in the user registration DB 40.

Since the information unique to the user and the information designated by the user are referenced in the selection of the digital content, the available digital content having a content generally faithfully reflecting the user's desire is produced.

In accordance with the present exemplary embodiment, the content delivery terminal 100 produces an available digital content by determining an output layout of the digital content based on the user information in the user information registration DB 40.

Since the information unique to the user and the information designated by the user are referenced in the determination of the digital content, the available digital content generally faithfully reflecting the user's desire is produced.

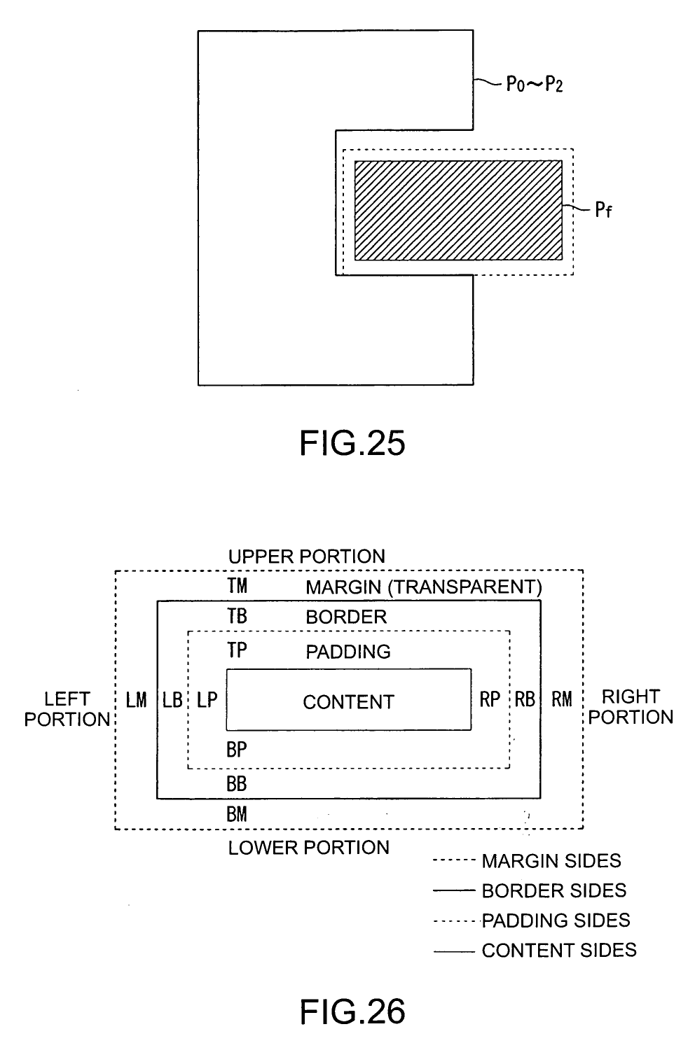

The drawing of the outline of a merged area that is obtained by merging the segmented information container frames has not been discussed in the description of the first and second exemplary embodiments. As shown in FIGS. 24 and 25, the outline of a merged area containing the text information container frames P0-P2 may be drawn.

FIG. 24 illustrates the drawn outlines of the text information container frames P0-P2.

FIG. 25 illustrates the drawn outline of the merged area containing the text information container frames P0-P2.

If the outlines of the text information container frames P0-P2 are drawn, a straight line is drawn on character containing areas as shown in FIG. 24, and the resulting layout can be destroyed. In the example of FIG. 24, affected portions may include a portion of the bottom side of the text information container frame P0, the top side and the bottom side of the text information container frame P1, and a portion of the top side of the text information container frame P2.

A portion of the outline of the text information container frame falling within another text information container frame is preferably left undrawn. More specifically, when the outline of the merged area is drawn, the outline of the merged area that is obtained by merging the segmented information container frames is determined in a first step. The outline of the merged area is then drawn based on the result of determination in a second step.

In the first step, an entire length of a side of the text information container frame is excluded as a candidate side forming the outline of the merged area if the side of the text information container frame entirely coextends with another text information container frame. A portion of the side is excluded as a candidate side forming the outline of the merged area if the portion of the side of the text information container frame coextends with another text information container frame. A side of the text information container frame is adopted as a candidate side forming the outline of the merged area if the side of the text information container frame does not coextend at all with another text information container frame. The sides of the outline of the merged area are determined based on the candidate sides determined on all sides of the text information container frames forming the merged area.

Only the outline of the merged area containing the text information container frames P0-P1 is drawn, as shown in FIG. 25.

Since the outline of the merged area is drawn, the plurality of segmented text information container frames is easily and visibly recognized as a logically unitary entity. The outline of the merged area is determined relatively precisely.

In accordance with the first and second exemplary embodiments, the text information container frame overlaps a single finalized container frame. The present invention is not limited to this case. The same method is applicable to the case in which the text information container frame overlaps a plurality of finalized container frames. In such a case, the text information container frame is segmented with respect to one finalized container frame. It is then determined whether one of the segmented information container frames overlap a next information container frame. If the segmented information container frame overlaps the finalized container frame, the segmented information container frame is further segmented. These steps are repeated.

In accordance with the first and second exemplary embodiments, the size of the internal margin of the text information container frame is adjusted. The present invention is not limited to this method. Alternatively, the size of the external margin of the text information container frame may be adjusted.

In accordance with the first and second exemplary embodiments, the text information container frame having the structure shown in FIG. 6 is handled. The present invention is not limited to this type of text information container frame. The present invention is applicable to a text information container frame having a structure (a box model of CSS2 (Cascading Style Sheets level 2)) shown in FIG. 26.

FIG. 26 shows the structure of the margins of such an information container frame.

In accordance with the first and second exemplary embodiments, the text information and the image information are used as the article information. The present invention is not limited to these pieces of information. Moving picture information, voice information, and multi-media data, etc., may also be used as the article information.

In accordance with the first and second exemplary embodiments, the layout process is performed while the shape and location of the information container frame are dynamically determined. The present invention is not limited to this method. Alternatively, in the layout process, information may be placed into all information container frames in the layout area 360 before the shape and location of each information container frame are determined.

In accordance with the first and second exemplary embodiments, the output layout of the digital content is determined based on the user information. The present invention is not limited to this method. Alternatively, the output layout of the digital content may be determined based on the number of images contained in the digital content or the amount of text information contained in the digital content.

Regardless of the number of images contained in the digital content and the amount of text information contained in the digital content, an output layout relatively easy to see is provided.

In accordance with the present exemplary embodiment, the content delivery terminal 100 performs the layout process in step S212. The present invention is not limited to this method. Alternatively, the user terminal 200 may perform the layout process. This arrangement reduces the concentration of workload on the content delivery terminal 100.

In accordance with the first exemplary embodiment, the processes of the flowcharts illustrated in FIGS. 11 through 14 are performed by executing the control program stored in the ROM 32. The present invention is not limited to this arrangement. A program describing the processes may be read from a storage medium to the RAM 34 before performing the processes.

In accordance with the second exemplary embodiment, the processes of the flowchart illustrated in FIG. 20 are performed by executing the control program stored in the ROM 32. The present invention is not limited to this arrangement. A program describing the processes may be read from a storage medium to the RAM 34 before performing the processes.

The storage medium may be a semiconductor storage medium, such as an RAM, or an ROM, a magnetic storage medium, such as an FD, or an HD, an optical storage medium, such as a CD, a CDV, an LD, or a DVD, or magnetic recording/optical reading type storage medium, such as an MO. The storage medium is thus any computer readable storage medium that permits data to be read electrically, mechanically, or optically.

In accordance with the first and second exemplary embodiments of the present invention, the layout system, the layout program, and the layout method are implemented in a network system including the Internet 199. The present invention is not limited to this arrangement. Alternatively, the present invention may be applied to a so-called intranet that performs the same communication as that of the Internet 199. The present invention is not limited to a network that performs the same communication method as that of the Internet 199, and may be applied to an ordinary network.

The layout system, the layout program, and the layout method in accordance with the first and second exemplary embodiments of the present invention are applied to the system in which the content delivery terminal 100 delivers the digital content, such as news, to the user terminal 200 as shown in FIG. 1. The present invention is not limited to such a system. The layout system, the layout program and the layout method may be applied to another system without departing from the scope of the present invention.

What is claimed is:

1. A layout system, comprising:
a layout device to lay out text information, the layout device laying out the text information by placing the text information into a plurality of text information container frames arranged in a predetermined layout area,
the text information container frame allowing a margin to be set to assure spacing with another text information container frame, and
the layout device adjusts the size of the margin and the placement location of one of the plurality of text information container frames so that a spacing between two text information container frames having consecutive lines in the proximity areas thereof is equal or substantially equal to a line height in each of the two text information container frames, when the text information is placed into the plurality of closely arranged text information container frames in a continuous manner.

2. A layout system, comprising:
a layout device to lay out text information, the layout device laying out the text information by placing the text information into a plurality of text information container frames arranged in a predetermined layout area,
the text information container frame allowing a margin to be set to assure spacing with another text information container frame, and
the layout device adjusts the size of the margin and the placement location of one of a plurality of text information container frames so that a line height between two text information container frames having a continuous character string of the text information in the proximity areas thereof and a line height in each of the two text information container frames fall within a predetermined range, when the text information is split and then placed into the plurality of closely arranged text information container frames.

3. A layout system, comprising:
a post information storage device to store a plurality of pieces of post information containing text information;
a post information selecting device to selecting the post information from among the plurality of pieces of post information in the post information storage device; and
a layout device to lay out the post information selected by the post information selecting device, the layout device laying out the post information by placing the post information into a plurality of text information container frames arranged in a predetermined layout area,
the text information container frame allowing a margin to be set to assure spacing with another text information container frame, and
the layout device adjusts the size of the margin and the placement location of one of the plurality of text information container frames so that a spacing between two text information container frames having consecutive lines in the proximity areas thereof is equal or substantially equal to a line height in each of the two text information container frames, when the text information is placed into the plurality of closely arranged text information container frames in a continuous manner.

4. A layout system, comprising:
a post information storage device to store a plurality of pieces of post information containing text information;
a post information selecting device to select the post information from among the plurality of pieces of post information in the post information storage device; and
a layout device to lay out the post information selected by the post information selecting device, the layout device laying out the post information by placing the post information into a plurality of text information container frames arranged in a predetermined layout area,
the text information container frame allowing a margin to be set to assure spacing with another text information container frame, and
the layout device adjusts the size of the margin and the placement location of one of the plurality of text information container frames so that a line height between two text information container frames having a continuous character string of the text information in the proximity areas thereof and a line height in each of the two text information container frames fall within a predetermined range, when the text information is split and then placed into the plurality of closely arranged text information container frames.

5. The layout system according to claim 3, the layout device including a text information container frame segmenting device to segment one text information container frame overlapping another text information container frame so that none of the text information container frames overlaps each other, a margin adjusting device to adjust the size of the margin and the placement location of a text information container frame segmented by the text information container frame segmenting device, and a text information splitting and placement device to place the post information, selected by the post information selecting device, into the text information container frames, segmented by the text information container frame segmenting device, in a continuous manner,
the margin adjusting device adjusts the size of the margin and the placement location of one of the plurality of text information container frames so that the spacing between two text information container frames having consecutive lines in the proximity areas thereof is equal or substantially equal to the line height in each of the two text information container frames.

6. The layout system according to claim 3, the layout device including a text information container frame segmenting device to segment one text information container frame overlapping another text information container frame so that none of the text information container frames overlaps each other, a margin adjusting device to adjust the size of the margin and the placement location of a text information container frame segmented by the text information container frame segmenting device, and a text information splitting and placement device to place the post information, selected by the post information selecting device, into the text information container frames, segmented by the text information container frame segmenting device, in a continuous manner,
the margin adjusting device adjusts the size of the margin and the placement location of one of the plurality of text information container frames segmented by the text information container frame segmenting device so that the line height between two text information container frames having a continuous character string of the text information in the proximity areas thereof and the line height in each of the two text information container frames fall within a predetermined range.

7. The layout system according to claim 5, the margin being an external margin arranged along and outside the outline of the text information container frame.

8. The layout system according to claim 5, the margin being an internal margin arranged along and inside the outline of the text information container frame.

9. The layout system according to claim 8, the text information container frame being a rectangular information container frame that receives text information in a horizontal writing format therewithin,
when a first text information container frame of the plurality of text information container frames is wider in width than a second text information container frame of the plurality of text information container frames, the margin adjusting device reducing the size of the internal margin on the top side of the second text information container frame to zero or almost zero and adjusting the placement location of the second text information container frame so that the top side of the second text information container frame is positioned at the upper edge of the internal margin of the bottom side of the first text information container frame, and
the text information splitting and placement device placing the post information, selected by the post information selecting device, into the first text information container frame, and placing a continuation of the post information, placed in the first text information container frame, into the second text information container frame.

10. The layout system according to claim 8, the text information container frame being a rectangular information container frame that receives text information in a horizontal writing character string format therewithin,
when the length of an adjacent first text information container frame of a plurality of text information container frames is longer in the direction of character string than the length of a second text information container frame of the plurality of text information container frames adjacent to the first text information container frame, the margin adjusting device reducing the internal margin of a side of the second text information container frame to be in contact with the first text information container frame to zero or almost zero, and adjusting the placement location of the second text information container frame so that the side of the second text information container frame to be in contact with the first text information container frame is positioned at the character string edge of the internal margin of a side of the first text information container frame to be in contact with the second text information container frame, and
the text information splitting and placement device placing the post information, selected by the post information selecting device, into the first text information container frame, and placing a continuation of the post information, placed in the first text information container frame, into the second text information container frame.

11. The layout system according to claim 8, the text information container frame being a rectangular information container frame that receives text information in a horizontal writing format therewithin,
when a first text information container frame of the plurality of text information container frames is narrower in width than a second text information container frame of the plurality of text information container frames, the margin adjusting device reducing the size of the internal margin on the bottom side of the first text information container frame to zero or almost zero and adjusting the placement location of the first text information container frame so that the bottom side of the first text information container frame is positioned at the lower edge of the internal margin of the top side of the second text information container frame, and
the text information splitting and placement device placing the post information, selected by the post information selecting device, into the first text information container frame, and placing a continuation of the post information, placed in the first text information container frame, into the second text information container frame.

12. The layout system according to claim 8, the text information container frame being a rectangular information container frame that receives text information in a horizontal writing character string format therewithin,
when the length of an adjacent first text information container frame of a plurality of text information container frames is shorter in the direction of character string than the length of a second text information container frame of the plurality of text information container frames adjacent to the first text information container frame, the margin adjusting device reducing the internal margin of a side of the first text information container frame to be in contact with the second text information container frame to zero or almost zero, and adjusting the placement location of the first text information container frame so that the side of the first text information container frame to be in contact with the second text information container frame is positioned at the character string edge of the internal margin of a side of the second text information container frame to be in contact with the first text information container frame, and
the text information splitting and placement device placing the post information, selected by the post information selecting device, into the first text information container frame, and placing a continuation of the post information, placed in the first text information container frame, into the second text information container frame.

13. The layout system according to claim 8, the text information container frame being a rectangular information container frame that receives text information in a vertical writing format therewithin,
when a first text information container frame of the plurality of text information container frames is longer in vertical length than a second text information container frame of the plurality of text information container frames, the margin adjusting device reducing the size of the internal margin on the right side of the second text information container frame to zero or almost zero and adjusting the placement location of the second text information container frame so that the right side of the second text information container frame is positioned at the right edge of the internal margin of the left side of the first text information container frame, and
the text information splitting and placement device placing the post information, selected by the post information selecting device, into the first text information container frame, and placing a continuation of the post information, placed in the first text information container frame, into the second text information container frame.

14. The layout system according to claim 8, the text information container frame being a rectangular information container frame that receives text information in a vertical writing character string format therewithin,
when the length of an adjacent first text information container frame of a plurality of text information container frames is longer in the direction of character string than the length of a second text information container frame of the plurality of text information container frames adjacent to the first text information container frame, the margin adjusting device reducing the internal margin of a side of the second text information container frame to be in contact with the first text information container frame to zero or almost zero, and adjusting the placement location of the second text information container frame so that the side of the second text information container frame to be in contact with the first text information container frame is positioned at the character string edge of the internal margin of a side of the first text information container frame to be in contact with the second text information container frame, and
the text information splitting and placement device placing the post information, selected by the post information selecting device, into the first text information container frame, and placing a continuation of the post information, placed in the first text information container frame, into the second text information container frame.

15. The layout system according to claim 8, the text information container frame being a rectangular information container frame that receives text information in a vertical writing format therewithin,
when a first text information container frame of the plurality of text information container frames is shorter in vertical length than a second text information container frame of the plurality of text information container frames, the margin adjusting device reducing the size of the internal margin on the left side of the first text information container frame to zero or almost zero and adjusting the placement location of the first text information container frame so that the left side of the first text information container frame is positioned at the left edge of the internal margin of the right side of the second text information container frame, and
the text information splitting and placement device placing the post information, selected by the post information selecting device, into the first text information container frame, and placing a continuation of the post information, placed in the first text information container frame, into the second text information container frame.

16. The layout system according to claim 8, the text information container frame being a rectangular information container frame that receives text information in a vertical writing character string format therewithin,
when the length of an adjacent first text information container frame of a plurality of text information container frames is shorter in the direction of character string than the length of a second text information container frame of the plurality of text information container frames adjacent to the first text information container frame, the margin adjusting device reducing the internal margin of a side of the first text information container frame to be in contact with the second text information container frame to zero or almost zero, and adjusting the placement location of the first text information container frame so that the side of the first text information container frame to be in contact with the second text information container frame is positioned at the character string edge of the internal margin of a side of the second text information container frame to be in contact with the first text information container frame, and
the text information splitting and placement device placing the post information, selected by the post information selecting device, into the first text information container frame, and placing a continuation of the post information, placed in the first text information container frame, into the second text information container frame.

17. The layout system according to claim 5, further comprising:
an outline determining device to determine an outline of a merged area that is obtained by merging the plurality of text information container frames segmented by the text information container frame segmenting means, and
an outline drawing device to drawing the outline of the merged area based on the results of determination of the outline determining device.

18. The layout system according to claim 17, the outline determining device excluding an entire length of a side of the text information container frame as a candidate side forming the outline of the merged area if the side of the text information container frame entirely coextends with another text information container frame, excludes a portion of the side as a candidate side forming the outline of the merged area if the portion of the side of the text information container frame coextends with another text information container frame, and adopts a side of the text information container frame as a candidate side forming the outline of the merged area if the side of the text information container frame does not coextend at all with another text information container frame, and the outline determining device determining the sides of the outline of the merged area based on the candidate sides determined on all sides of the text information container frames forming the merged area.

19. The layout system according to claim 3, further comprising:
a user information storage device to store user information relating to a user, the post information selecting device selecting the post information from among the plurality of pieces of post information based on the user information in the user information storage device.

20. The layout system according to claim 3, comprising:
a user information storage device that stores user information relating to a user, the post information selecting device selecting the post information from among the plurality of pieces of post information based on the user information in the user information storage device.

21. The layout system according to claim 3, further comprising:
a user information storage device to store user information relating to a user, the layout device laying out the post information, selected by the post information selecting device, based on the user information in the user information storage device.

22. The layout system according to claim 3, further comprising:
a user information storage device that stores user information relating to a user, the layout device laying out the post information, selected by the post information selecting device, based on the user information in the user information storage device.

23. A program to cause a computer to perform a process of the layout device in a layout system according to claim 1,
the text information container frame allowing a margin to be set to assure spacing with another text information container frame, and
the layout device adjusts the size of the margin and the placement location of one of the plurality of text information container frames so that the spacing between two text information container frames having consecutive lines in the proximity areas thereof is equal or substantially equal to the line height in each of the two text information container frames, when the text information is placed into the plurality of closely arranged text information container frames in a continuous manner.

24. A program to cause a computer to perform a process of the layout device in a layout system according to claim 1,
the text information container frame allowing a margin to be set to assure spacing with another text information container frame, and
the layout device adjusts the size of the margin and the placement location of one of the plurality of text information container frames so that the line height between two text information container frames having consecutive lines in the proximity areas thereof and the line height in each of the two text information container frames fall within a predetermined range, when the text information is placed into the plurality of closely arranged text information container frames in a continuous manner.

25. A layout method, comprising:
laying out text information, including placing the text information into a plurality of text information container frames arranged in a predetermined layout area,
the text information container frame allowing a margin to be set to assure spacing with another text information container frame, and
the size of the margin and the placement location of one of the plurality of text information container frames adjusted in the layout step so that the spacing between two text information container frames having consecutive lines in the proximity areas thereof is equal or substantially equal to the line height in each of the two text information container frames, when the text information is placed into the plurality of closely arranged text information container frames in a continuous manner.

26. A layout method, comprising:
laying out text information, including placing the text information into a plurality of text information container frames arranged in a predetermined layout area,
the text information container frame allowing a margin to be set to assure spacing with another text information container frame, and
the size of the margin and the placement location of one of the plurality of text information container frames adjusted in the layout step so that the line height between two text information container frames having consecutive lines in the proximity areas thereof and the line height in each of the two text information container frames fall within a predetermined range, when the text information is placed into the plurality of closely arranged text information container frames in a continuous manner.
